(19) United States
(12) Patent Application Publication
(10) Pub. No.: US 2006/0166057 A1
(43) Pub. Date: Jul. 27, 2006

(54) Method of making nanoparticulates and use of the nanoparticulates to make products using a flame reactor

(75) Inventors: Toivo T. Kodas, Albuquerque, NM (US); David E. Dericotte, Albuquerque, NM (US); George P. Fotou, Albuquerque, NM (US)

Correspondence Address: Jaimes Sher, Esq.;Cabot Corporation, 5401 Venice Avenue NE, Albuquerque, NM, 87113, US

(73) Assignee: Cabot Corporation, Boston, MA (US)

(21) Appl. No.: 11/335,727

(22) Filed: Jan. 20, 2006

Related U.S. Application Data
(60) Provisional application No. 60/645,985, filed on Jan. 21, 2005.

(51) Int. Cl. C22B 3/00; H01M 8/04

(52) U.S. Cl. 429/22; 423/1; 977/900

(57) ABSTRACT

The present invention relates to a method of making nanoparticulates in a flame reactor, the nanoparticulates having controlled properties such as weight average particle size, composition and morphology. The nanoparticulates made with the method of present invention may be tailored to a specific weight average particle size range, such as from about 1 nm to about 500 nm. In addition to weight average particle size, the nanoparticulates made with the method of the present invention may include a variety of materials including metals, ceramics, organic materials, and combinations thereof. Moreover, the method of the present invention allows control over the morphology of the nanoparticulates, which allows the production of nanoparticulates with any desired morphology including spheroidal and unagglomerated; and agglomerated (aggregated) into larger units of hard aggregates.

### CROSS REFERENCE TO RELATED APPLICATION

This application claims the benefit of U.S. Provisional Application Ser. No. 60/645,985, filed Jan. 21, 2005, the entire contents of which are incorporated herein by reference.

### FIELD OF INVENTION

The present invention relates to a manufacture of nanoparticulates, and more particularly involving use of a flame reactor, including manufacture of nanoparticulates with particular properties such as particle size, composition and morphology.

### BACKGROUND OF THE INVENTION

There is currently a heightened interest in the use of nanoparticulates for a variety of applications. However, nanoparticulates may range significantly in size and other properties. For example, primary particles may range in size from 1 nm and 500 nm and still be considered nanoparticulates. For different applications, however, different particle sizes or different particle size distributions may be desired for product or processing requirements. Also, for some applications, different characteristics for other properties may be desired, such as the density or morphology of the nanoparticulates.

For example, in some applications it may be desirable to have smaller-size nanoparticulates, while for other applications larger-size nanoparticulates may be desired. Additionally, for some applications it may be preferred that the nanoparticulates be spherical and unagglomerated, while in other applications it may be preferred that the nanoparticulates be agglomerated, or aggregated, into larger units of hard aggregates. Also, desired properties of the nanoparticulates may vary depending upon the composition of the nanoparticulates.

Current processes for making nanoparticulates have achieved some success in making nanoparticulates with different compositions and other properties, but there is a significant need for new processes that provide additional capabilities to satisfy a need for a broader range of different nanoparticulate compositions and properties.

### SUMMARY OF THE INVENTION

The present invention is directed to making nanoparticulates of a variety of compositions and with a variety of particle properties using a flame reactor, making products using such nanoparticulates and the products so made.

In one aspect, the present invention is directed to a method of making nanoparticulates that include a low-melting temperature material. The method includes introducing into a flame reactor a nongaseous precursor that has a component for inclusion in the low-melting temperature material of the nanoparticulates. The nanoparticulates are formed in a flowing stream within the flame reactor. Forming of the nanoparticulates includes transferring substantially all of the component in the nongaseous precursor through a gas phase of the flowing stream in the flame reactor. Forming the nanoparticulates also includes growing the nanoparticulates in the flowing stream to a weight average particle size having an upper limit of 500 nanometers. In one implementation of this first aspect, the growing includes maintaining the flowing stream and the nanoparticulates at an elevated temperature in a second zone of the flame reactor for a sufficient residence time for the nanoparticulates to grow into the desired weight average particle size range. In this implementation, the nanoparticulates are maintained in the second zone at an elevated temperature for a residence time sufficient so that nanopaticulates collide, and join to form nanoparticulates of larger weight average particle size.

Another aspect of the present invention is directed to a method of making metal-containing nanoparticulates. The method includes introducing into a flame reactor a nongaseous precursor that has metal for inclusion in the nanoparticulates. The nanoparticulates are formed in a flowing stream within the flame reactor. Forming the nanoparticulates includes transferring substantially all of the metal in the nongaseous precursor through a gas phase of the flowing stream in the flame reactor. Forming the nanoparticulates also includes growing the nanoparticulates that include the metal in the flowing stream to a weight average particle size having a lower limit of 1 nanometer and an upper limit of 500 nanometers. In one embodiment, the making metal-containing nanoparticulates comprise nanoparticulates selected from the group consisting of catalyst particles, phosphor particles, magnetic particles and particles with specific electrical properties (e.g., conductive, resistive, dielectric, etc.). In another embodiment, the process further comprises the steps of: collecting the making metal-containing nanoparticulates; and dispersing the making metal-containing nanoparticulates in a liquid medium. The liquid medium may then be applied onto a surface (e.g., by ink jet printing, screen printing, intaglio printing, gravure printing, flexographic printing, and lithographic printing). The surface may, in turn, be heated to a maximum temperature below 500° C. to form at least a portion of an electronic component. In the alternative, the surface may be heated to a maximum temperature below 500° C. to form at least a portion of a feature selected from the group consisting of a conductor, resistor, phosphor, dielectric, and transparent conducting oxide. The feature may comprise a ruthenate resistor (i.e., a resistor comprising a mixed metal oxide that contains ruthenium, including, but not limited to bismuth ruthenium oxide, and strontium ruthenium oxide); a phosphor; or a titanate dielectric. In another embodiment, the process further comprises the steps of: collecting the making metal-containing nanoparticulates; and (d) forming an electrode from the making metal-containing nanoparticulates. The electrode may comprise a fuel cell electrode. In another embodiment, the making metal-containing nanoparticulates exhibit corrosion resistance. In still another embodiment, the making metal-containing nanoparticulates exhibit high temperature thermal stability and high surface area. In a preferred embodiment, the metal-containing nanoparticulates maintain a surface area of at least 30 m2/g after exposure to air at 900° C. for 4 hours. In still another embodiment, the process further comprises the steps of: collecting the making metal-containing nanoparticulates; and forming an optical feature from the metal-containing nanoparticulates. Optical features are described, for example, in co-pending U.S. Patent Application bearing Attorney Docket No. 2006A002, entitled “Security Features, Their Use, and Processes for Making Them,” filed on Jan. 13, 2006, the entirety of which is incorporated herein by reference.

Another aspect of the present invention is directed to a method of making nanoparticulates involving a quench prior to completion of the growth of the nanoparticulates. The method includes introducing a nongaseous precursor, which is a first precursor, into a flame reactor, with the nongaseous precursor including a component for inclusion in a material of the nanoparticulates. Forming the nanoparticulates includes transferring substantially the entire component of the precursor through a gas phase of a flowing stream in the flame reactor. Forming the nanoparticulates also includes growing the nanoparticulates in the flowing stream to a size range having a lower limit of 1 nanometer and an upper limit of 500 nanometers. The flowing stream is quenched prior to completion of the growing, to reduce the temperature of the nanoparticulates, with an option that at least a portion of the nanoparticulate growth occurs after the quench.

In another aspect, the present invention is directed to a method for making nanoparticulates involving separate addition of at least two precursors. The method includes introducing into a flame reactor, at a first location, a nongaseous precursor that includes a component for inclusion in a material of the nanoparticulates. Forming the nanoparticulates comprises transferring substantially the entire component of the nongaseous precursor through a gas phase of a flowing stream in the flame reactor. A second precursor for the nanoparticulates is added to the flowing stream at a second location in the flame reactor, with the second location being downstream of the first location. Forming the nanoparticulates also includes growing the nanoparticulates in the flowing stream to a weight average particle size having a lower limit of 1 nanometer and an upper limit of 500 nanometers. In one implementation of this aspect, the second precursor is the same as the nongaseous precursor. In another implementation of this aspect, the second precursor is a different precursor than the nongaseous precursor.

In another aspect, the present invention is directed to a method of making multi-phase nanoparticulates involving a flux components that aid growth of the nanoparticulates. The method includes introducing a first precursor into a flame reactor, with the first precursor being a nongaseous precursor that includes a component for a first phase of the nanoparticulates. A second precursor is introduced into the flame reactor, with the second precursor including a different component for a second phase of the nanoparticulates. Forming the nanoparticulates includes transferring substantially all of the component of the first precursor through a gas phase of a flowing stream in the flame reactor, and growing the nanoparticulates in the flowing stream to a weight average particle size in a range having a lower limit of 1 nanometer and an upper limit of 500 nanometers and including both the first phase and the second phase. The second phase aids growth of the nanoparticulates. In one implementation, substantially all of the second phase is on an outside surface of the nanoparticulates to create a surface on the nanoparticulates that promotes the joining of two nanoparticulates that collide during the growing nanoparticulates.

Another aspect of the present invention is directed to a method of making multi-phase nanoparticulates involving at least two phases with different melting temperatures. The method includes introducing a first precursor into a flame reactor, with the first precursor being a nongaseous precursor that includes a component for material of a first phase of the nanoparticulates. A second precursor is introduced into the flame reactor, with the second precursor including a different component for inclusion in a second phase of the nanoparticulates. Forming the nanoparticulates includes transferring substantially all of the component of the first precursor through a gas phase of a flowing stream in the flame reactor, and growing the nanoparticulates in the flowing stream to a weight average particle size in a range having a lower limit of 1 nanometer and an upper limit of 500 nanometers and including both the first phase and the second phase. The second phase has a lower melting temperature than the first phase, and the growing comprises maintaining the flowing stream for some period of time above the melting temperature of the second phase and below the melting temperature of the first phase. In one implementation of this aspect, the second phase aids in growing the nanoparticulates by providing a liquid on the surface of the nanoparticulates during the growing nanoparticulates.

Another aspect of the present invention is directed to a method of making nanoparticulates involving control of the temperature of a process conduit wall to inhibit thermophoretic deposition. The method includes introducing a nongaseous precursor into a flame reactor, with the nongaseous precursor including a component for a material of the nanoparticulates. Forming the nanoparticulates includes transferring substantially all of the component of the nongaseous precursor through a gas phase of a flowing stream in the flame reactor, and growing the nanoparticulates in the flowing stream to a weight average particle size in a range having a lower limit of 1 nanometer and an upper limit of 500 nanometers. During the growing the flowing stream flows through a conduit, and an interior wall portion of the conduit that is adjacent to the flowing stream is maintained at or above a temperature of the flowing stream during the growing.

Another aspect of the present invention is directed to a method of making nanoparticulates involving use of a barrier gas adjacent a wall to inhibit thermophoretic deposition. The method includes introducing a nongaseous precursor into a flame reactor, with the nongaseous precursor including a component for inclusion in a material of the nanoparticulates. Forming the nanoparticulates includes transferring substantially all of the component of the nongaseous precursor through a gas phase of a flowing stream in the flame reactor, and growing in the flowing stream the nanoparticulates to a weight average particle size in a range having a lower limit of 1 nanometer and an upper limit of 500 nanometers. During at least a portion of the growing, a barrier gas is flowed adjacent to a wall of the flame reactor.

In another aspect, the present invention is directed to a method of making nanoparticulates involving use of a barrier gas around a flame. The method includes introducing into a flame of a flame reactor a nongaseous precursor, with the nongaseous precursor including a component for inclusion in a material of the nanoparticulates. Forming the nanoparticulates includes transferring substantially all of the component of the nongaseous precursor through a gas phase of a flowing stream in the flame reactor, and growing the nanoparticulates in the flowing stream to a weight average particle size in a range having a lower limit of 1 nanometer and an upper limit of 500 nanometers. During at least a portion of the introducing, a barrier gas flows around the outer periphery of the flame. In one implementation of this aspect, some of the nanoparticulates are formed within the flame and the barrier gas inhibits migration of the nanoparticulates to a wall of the flame reactor, thereby also inhibiting deposition on the wall.

In another aspect, of the present invention is directed to a method of making nanoparticulates involving flame control with use of an aperture through which the flame projects. The method includes introducing into a flame a nongaseous precursor with the nongaseous precursor including a component for inclusion in a material of the nanoparticulates. Forming the nanoparticulates includes transferring substantially all of the component of the nongaseous precursor through a gas phase of a flowing stream in the flame reactor, and growing the nanoparticulates while in the flowing stream to a weight average particle size in a range having a lower limit of 1 nanometer and an upper limit of 500 nanometers. The flame, into which the precursor is introduced, discharges into a conduit and the flame projects through an aperture of smaller area than a cross-sectional area of the conduit in a plane perpendicular to the direction of flow of the flowing stream. In one implementation of this aspect, thermophoretic deposition of nanoparticulates is inhibited through focusing the flame through the smaller area of the aperture.

In another aspect, the present invention is directed at a method of making nanoparticulates involving separate introduction into the flame reactor of at least two different nongaseous precursors. The method includes introducing into a flame reactor a first nongaseous precursor and a second nongaseous precursor, with each of the first nongaseous precursor and the second nongaseous precursor including a component for the nanoparticulates. Forming the nanoparticulates includes transferring substantially the entire component of each of the first nongaseous precursor and the second nongaseous precursor through a gas phase in the flame reactor, and growing the nanoparticulates to a weight average particle size in a range having a lower limit of 1 nanometer and an upper limit of 500 nanometers. During the introducing, the first nongaseous precursor and the second nongaseous precursor are separately introduced into the flame reactor.

In another aspect, the present invention is directed to a method of making nanoparticulates involving introducing different portions of nongaseous precursor into different ones of multiple flames. The method includes introducing into a flame reactor a nongaseous precursor including a component for a material of the nanoparticulates. Forming the nanoparticulates includes transferring substantially all of the component through a gas phase in the flame reactor, and growing the nanoparticulates to a weight average particle size in a range having a lower limit of 1 nanometer and an upper limit of 500 nanometers. The flame reactor includes a plurality of flames and when the nongaseous precursor is introduced into the flame reactor, a different portion of the nongaseous precursor is introduced into each of two or more of the plurality of flames.

In another aspect, the present invention is directed to the use of nanoparticulates comprising a low-melting temperature material having a melting temperature of less than 2000° C. for the fabrication of at least a portion of a feature selected from the group consisting of a conductor, resistor, phosphor, dielectric, and transparent conducting oxide.

### BRIEF DESCRIPTION OF THE DRAWINGS

The present invention will be better understood in view of the following non-limiting figures, wherein:

FIG. 1 shows a generalized process block-diagram of one embodiment of the method of the present invention for forming nanoparticulates;

FIG. 2 shows a flame reactor that may be used to implement one embodiment of the method of the present invention that includes introducing a nongaseous precursor through a burner and into a flame;

FIG. 3 shows a flame reactor that may be used to implement one embodiment of the method of the present invention that includes introducing a nongaseous precursor into a flame without introduction through a burner;

FIG. 4 shows a flame reactor that may be used to implement one embodiment of the method of the present invention that includes introducing a nongaseous precursor downstream of a flame;

FIG. 5 shows a generalized process block-diagram of one embodiment of the method of the present invention for forming nanoparticulates that includes transferring a component into a gas phase and growing nanoparticulates;

FIG. 6 shows a flame reactor that may be used to implement one embodiment of the method of the present invention that includes growing nanoparticulates;

FIG. 7 shows another flame reactor that may be used to implement one embodiment of the method of the present invention that includes growing nanoparticulates;

FIG. 8 shows another flame reactor that may be used to implement one embodiment of the method of the present invention that includes growing nanoparticulates;

FIG. 9 shows yet another flame reactor that may be used to implement one embodiment of the method of the present invention that includes growing nanoparticulates;

FIG. 10 shows another flame reactor that may be used to implement one embodiment of the method of the present invention that includes growing nanoparticulates;

FIG. 11 shows another flame reactor that may be used to implement one embodiment of the method of the present invention that includes introducing additional material into a flame reactor to grow nanoparticulates;

FIG. 12 shows a generalized process block-diagram of one embodiment of the method of the present invention for forming nanoparticulates that includes quenching nanoparticulates;

FIG. 13 s shows a flame reactor that may be used to implement the embodiment of the present invention shown in FIG. 12;

FIG. 14 shows a generalized process block-diagram of one embodiment of the method of the present invention for forming nanoparticulates that includes quenching and growing nanoparticulates;

FIG. 15 shows a flame reactor that may be used to implement the embodiment of the present invention shown in FIG. 14;

FIG. 16 shows a generalized process block-diagram of one embodiment of the method of the present invention for forming nanoparticulates that includes two quenching nanoparticulates steps;

FIG. 17 shows a flame reactor that may be used to implement the embodiment of the present invention shown in FIG. 16;

FIG. 18 shows a generalized process block-diagram of one embodiment of the method of the present invention for forming nanoparticulates that includes quenching and modifying nanoparticulates steps;

FIG. 19 shows a flame reactor that may be used to implement one embodiment of the method of the present invention that includes growing and modifying nanoparticulates;

FIG. 20 shows a plurality of flames that may be used in a flame reactor for implementing one embodiment of the method of the present invention that includes introducing nongaseous precursor into the plurality of flames;

FIG. 21 shows a plurality of flames that may be used in a flame reactor for implementing one embodiment of the method of the present invention that includes introducing nongaseous precursor into only some of the plurality of flames;

FIG. 22 shows a plurality of flames that may be used in a flame reactor for implementing one embodiment of the method of the present invention that includes introducing two different feeds of nongaseous precursor into the plurality of feeds;

FIG. 23A shows one embodiment for arranging a plurality of burners that may be used in a flame reactor for implementing the method of the present invention;

FIG. 23B shows a second embodiment for arranging a plurality of burners that may be used in a flame reactor for implementing the method of the present invention;

FIG. 23C shows a third embodiment for arranging a plurality of burners that may be used in a flame reactor for implementing the method of the present invention;

FIG. 24 shows a slot burner that may be used in a flame reactor for implementing a method of the present invention that includes introducing the same feed into each channel of a multi-channel burner;

FIG. 25 shows a slot burner that may be used in a flame reactor for implementing a method of the present invention that includes introducing two different feeds into a multi-channel burner;

FIG. 26 shows a slot burner that may be used in a flame reactor for implementing a method of the present invention;

FIG. 27 shows a slot burner that may be used in a flame reactor for implementing a method of the present invention that includes introducing a barrier gas into the outermost channels of a multi-channel burner;

FIG. 28 shows a slot burner that may be used in a flame reactor for implementing a method of the present invention that includes introducing a barrier gas into at least one channel of a multi-channel burner;

FIG. 29 shows a square burner that may be used in a flame reactor for implementing a method of the present invention;

FIG. 30 shows a honeycomb burner that may be used in a flame reactor for implementing a method of the present invention;

FIG. 31 shows a flame reactor that may be used to implement one embodiment of the method of the present invention that includes addition of a barrier gas along a wall of a flame reactor;

FIG. 32 shows a flame reactor that may be used to implement one embodiment of the method of the present invention that includes addition of a barrier gas around a perimeter of a flame;

FIG. 33 shows a flame reactor that may be used to implement one embodiment of the method of the present invention, the flame reactor including a wall with an aperture, a flame being disposed within the aperture;

FIG. 34 shows a generalized process block-diagram of one embodiment of the method of the present invention for forming nanoparticulates that includes a generating flowing stream step;

FIG. 35 shows a generalized process block-diagram of of one embodiment of the method of the present invention for forming nanoparticulates that includes a generating flowing stream step followed by a drying disperse phase step;

FIG. 36 shows a generalized process block-diagram of of one embodiment of the method of the present invention for forming nanoparticulates that includes a collecting nanoparticulates step;

FIG. 37 shows an example of unagglomerated nanoparticulates that may be made with the method of the present invention;

FIG. 38 shows an example of an agglomerate unit of nanoparticulates that may be made with the method of the present invention; and

FIG. 39 shows a flame reactor that may be used to implement one embodiment of the method of the present invention involving introduction of nongaseous precursor downstream of a flame.

### DETAILED DESCRIPTION OF THE INVENTION

In one aspect, the present invention is directed to a method of making nanoparticulates using a flame reactor. By a flame reactor, it is meant a reactor having an internal reactor volume directly heated by one or more than one flame when the reactor is operated. By directly heated, it is meant that the hot discharge of a flame flows into the internal reactor volume. By the term flame, it is meant a luminous combustion zone.

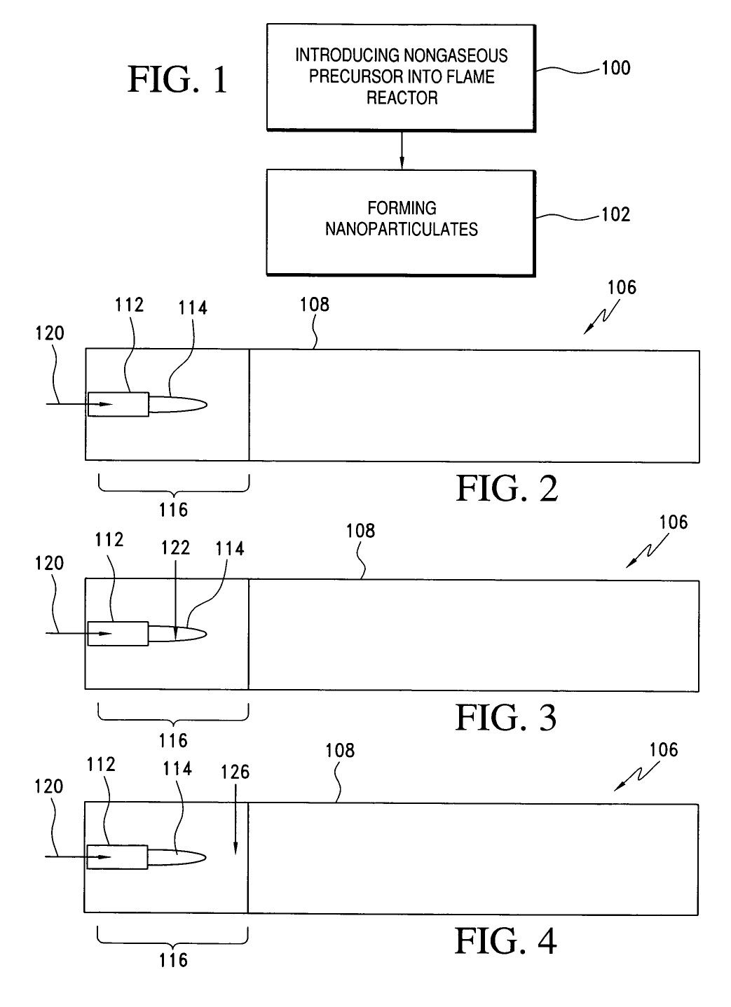

FIG. 1 shows a generalized process-block diagram of a general embodiment of a method of making nanoparticulates according to the present invention. As shown in FIG. 1, the method includes introducing 100 into a flame reactor nongaseous precursor for the nanoparticulate followed by forming 102 the nanoparticulates.

During the introducing 100, the nongaseous precursor is introduced into the flame reactor in any convenient way. By being introduced into the flame reactor, it is meant that the nongaseous precursor is either introduced into one or more than one flame of the reactor (i.e., delivered as feed to the flame) or introduced into a hot zone in the internal reactor volume directly heated by one or more than one flame.

By nongaseous, it is meant that the precursor is not in a vapor state. Rather, as introduced into the flame reactor, the nongaseous precursor will be, or be part of, one or more of a liquid, a solid or a supercritical fluid. For example, the nongaseous precursor may be contained in a liquid phase, solid phase or supercritical fluid phase of feed to the flame reactor. In one convenient and preferred implementation, during the introducing 100 the nongaseous precursor is contained within a nongaseous disperse material, such as in disperse droplets, particles. For example, the nongaseous precursor may be contained in droplets of liquid sprayed into the flame or into a hot zone in the internal reactor volume. In one embodiment, the nongaseous precursor will be in a disperse phase of a flowing feed stream, in which the disperse phase is dispersed in a gas phase when introduced into the flame reactor. In yet another embodiment, the nongaseous precursor may be dissolved in a supercritical fluid that is introduced into the flame reactor. As the supercritical fluid expands upon introduction into the flame reactor, typically to a gaseous state, the capacity of the fluid as a solvent is reduced and the nongaseous precursor precipitates. A preferred supercritial fluid is carbon dioxide although other supercritical fluids could be used instead.

The nongaseous precursor includes at least one component for inclusion in the nanoparticulates. By “component” it is meant at least some identifiable portion of the nongaseous precursor that becomes a part of the nanoparticulates. For example, the component could be the entire composition of the nongaseous precursor when that entire composition is included in the nanoparticulates. More often, however, the component will be something less than the entire composition of the nongaseous precursor, and may be only a constituent element present in both the composition of the nongaseous precursor and the nanoparticulates. For example, it is often the case that in the flame reactor the nongaseous precursor decomposes, and one or more than one element in a decomposition product then becomes part of the nanoparticulates, either with or without further reaction of the decomposition product.

With continued reference to FIG. 1, during the forming 102, the nanoparticulates are formed in a flowing stream of the flame reactor. As used herein, the flame reactor includes all equipment and apparatus forming a flow path through one or more than one flame and downstream until the nanoparticulates have been removed from the flow path. The internal reactor volume, noted above, therefore includes all portions of each such flow path through which any discharge of a flame flows until removal of the nanoparticulates from the flow. Therefore, for example, the flame reactor, as used herein, includes all equipment and apparatus fluidly interconnected with one or more flames, regardless of the process operation being performed in the apparatus or equipment. For example, the flame reactor may include equipment and apparatus fluidly interconnected downstream of the flame to grow, modify, or quench the nanoparticulates.

As used herein, the term “nanoparticulates”, means particles, whether primary particles or aggregates of primary particles, having a weight average particle size of not larger than 500 nm, and more typically a weight average particle size in a range of from 1 nm to 500 nm.

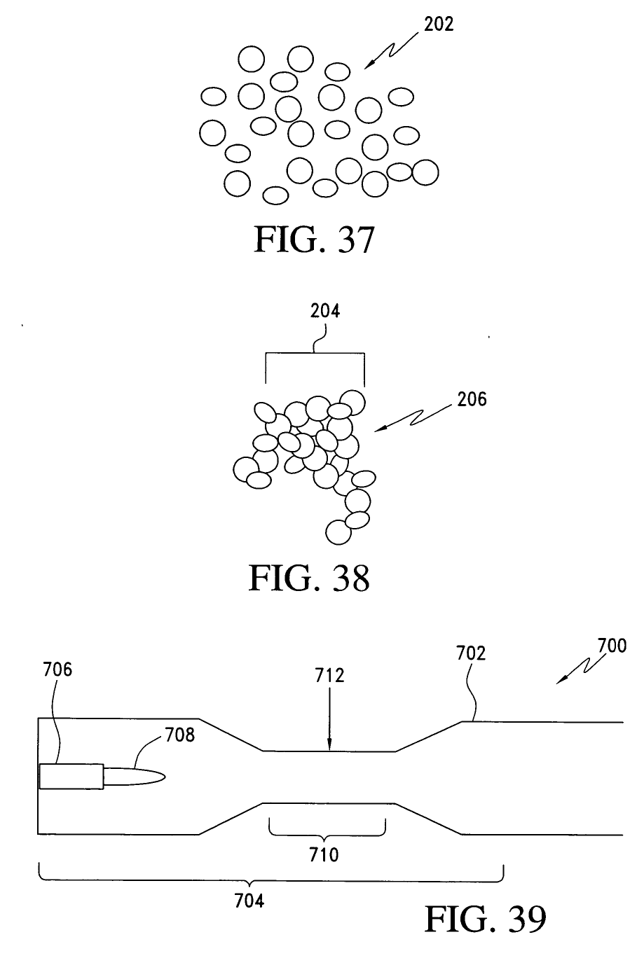

By “primary particles”, it is meant indentifiable particulate domains that are either substantially unagglomerated (i.e., substantially unattached to each other) or if agglomerated never the less retain the identifiable particulate attributes, in that the particulate domains are joined together through necking between the still identifiable separate particulate domains. In some embodiments of the invention, the nanoparticulates are substantially unagglomerated, while in other embodiments the nanoparticulates may be in the form of agglomerates (also called aggregates) which may be hard agglomerates (meaning that the agglomerates are not easy to break apart to release the individual nanoparticulates). As will be appreciated, when the nanoparticulates are in the form of agglomerates, the agglomerate units will be of a much larger size than the nanoparticulates. Such agglomerate units may include only two nanoparticulates or may comprise dozens or even hundreds or more of the nanoparticulates. FIG. 37 illustrates one example of unagglomerated nanoparticulates 202, and FIG. 38 illustrates an agglomerate unit 204 including multiple nanoparticulates 206 joined through necking of the identifiable domains of the primary particles. In most, but not all embodiments, it is preferred that the nanoparticulates made according to a method of the invention are either substantially unagglomerated or in the form of soft agglomerates that are easily broken up.

In one preferred embodiment, the nanoparticulates made with the method of the present invention are spheroidal. By the term “spheroidal” it is meant a shape that is either spherical or resembles a sphere even if not perfectly spherical. For example such spheroidal nanoparticulates, although of rounded form, may be elongated or oblong in shape relative to a true sphere. As another example, such spheroidal nanoparticulates may have faceted or irregular surfaces other than the rounded surfaces of a sphere. Also, the nanoparticulates may have significant internal porosity or may be very dense, with particles of higher density generally being preferred. In one implementation, the nanoparticulates have a density of at least 80 percent, or at least 85 percent or even at least 90 percent of theoretical density for the composition of the nanoparticulates, as measured by helium pyconometry. In some applications, however, it may be desirable to have very large specific surface area, the nanoparticualtes may include a significant amount of porosity.

The nanoparticulates may be made according to different implementations of the method of the invention to include only a single phase or may be multi-phase (also called composite) nanoparticulates including two or more different phases. In those instances in which the nanoparticulates are multi-phase particles, the different phases may be distributed within the nanoparticulates in any of a variety of morphologies. For example, two or more of the phases may be intimately mixed together, or one or more phases may form a core phase surrounded by a shell of one or more other phases that form a shell (or covering) about the core, or one or more phases may be in the form of a dispersion dispersed in a matrix comprised of one or more other phases, or one or more phases forming one hemisphere and one or more other phases forming a second hemisphere of the nanoparticulates. Such multi-phase nanoparticulates include at least two phases, but may include three, four or even more than four phases.

The nanoparticulates may be made by various implementations of the method of the preset invention for a wide variety of applications. Depending upon the final application, the nanoparticulates may, therefore, be made with a wide variety of compositions and other properties. For example, the nanoparticulates may be transparent (such as for use in display applications), electrically conductive (such as for use in electronic conductor applications), electrically insulative (such as for use in resistor applications), thermally conductive (such as for use in heat transfer applications), thermally insulative (such as for use in a heat barrier application) or catalytically active (such as for use in catalysts applications). Nonlimiting examples of possible properties of the nanoparticulates for use in other applications include: semiconductive, luminescent, magnetic, electrochromic, capacitive, bio-reactive and bio-ceramic.

Table 1 lists some nonlimiting examples of materials that may be included in the nanoparticulates made with various implementations of the method of the present invention. Table 1 also lists some exemplary applications for nanoparticulates that may include the listed materials. Other nonlimiting examples of materials that may be included in the nanoparticulates made with various implementations of the method of the present inventions are each and every one of the materials disclosed for inclusion in nanoparticulates in U.S. Provisional Patent Application No. 60/599,847, entitled “GAS DISPERSION MANUFACTURE OF NANOPARTICULATES, AND NANOPARTICULATE-CONTAINING PRODUCTS AND PROCESSING THEREOF,” filed Aug. 7, 2004, the entire contents of which are hereby incorporated herein as if set forth herein in full.

TABLE 1

| Nanoparticulate | | |
|---|---|---|
| Material | Example Formula | Exemplary Applications |
| Simple Oxides | | |
| Alumina | Al₂O₃ | Chemical Mechanical |
| | | Planarization (CMP) |
| Magnesia | MgO | CMP |
| Ceria | CeO₂ | Catalysis, Optics, CMP |
| Zirconia | ZrO₂ | CMP |
| Titania | TiO₂ | Pigments, Catalysis |
| Titanium suboxide | TiO | Pigments |
| Silica | SiO₂ | Ceramics |
| Iron oxides | Fe₂O₃, Fe₃O₄ | Electronics, recording |
| | | media |
| Zinc Oxide | ZnO | Electronics, recording |
| | | media |
| Tin oxide | SnO | Electronics, recording |
| | | media |
| Bismuth oxide | Bi₂O₃ | Electronics, recording |
| | | media |
| Yttria | Y₂O₃ | Optics |
| Calcium oxide | CaO | Catalysis |
| Strontium oxide | SrO | Ceramic, Catalysis |
| Nickel oxide | NiO | Catalysis, Electronics |
| Ruthenium oxide | RuO | Electronics |
| Indium tin oxide | | Electronics |
| (ITO) | | |
| Aluminates | | |
| Calcium aluminate | CaAl₂O₄ | Ceramics |
| Magnesium | MgAl₂O₄ | Ceramics |
| aluminate | | |
| Barium aluminate | BaAl₂O₄ | Ceramics |
| Strontium | SrAl₂O₄ | Ceramics |
| aluminate | | |
| Silicates | | |
| Zinc silicate | Zn₂SiO₄ | Optics |
| Yttrium silicate | Y₂SiO₅ | Optics |
| Titanates | | |
| Barium titanate | BaTiO₃ | Electronic |
| Strontium titanate | SrTiO₃ | Electronic |
| Aluminum titanate | AlTiO | Ceramics |
| Barium-strontium | (Ba₍₁₋ₓ₎Srₓ₎TiO₃ | Electronics |
| titanate | | |
| Mixed or Complex | | |
| Oxides | | |
| Ceria-zirconia | CeO₂:ZrO₂ | Catalysis (automotive) |
| YSZ | ZrO₂:Y₂O₃ | Ceramics, Sensors |
| Alumina-silica | 3Al₂O₃:2SiO₂ | Ceramics |
| (Mullite) | | |
| Strontia-alumina- | SrO—Al₂O₃—SiO₂ | Ceramics |
| silica | | |
| Zinc-silica | ZnO—SiO₂ | Electronic |
| Idium tin oxide | | Electronic, transparent |
| (ITO) | | conductor |
| Metals | | |
| Cobalt | Co | Optics |
| Copper | Cu | Electronics, Optics |
| Silver | Ag | Electronics, Optics |
| Gold | Au | Electronic |
| Platinum | Pt | Catalysis |
| Iridium | Ir | Catalysis |
| Metals on metal | | |
| oxides | | |
| Platinum on | Pt:Al₂O₃ | Catalysis |
| alumina | | |
| Platinum on tin | Pt:SnO₂ | Electronic |
| oxide | | |
| Platinum on | Pt:TiO₂ | Catalysis |
| titania | | |
| Silver on alumina | Ag:Al₂O₃ | Catalysis |
| Gold on titania | Au:TiO₂ | Electronic |
| Gold on Silica | Au:SiO₂ | Electronic |
| Complex | | |
| Compositions | | |
| Ferrites | | Electronic |
| Chromates | | Electronic |
| Superconductors | YBaCuO | Electronic |
| Metal Doped | | |
| Materials | | |
| Europia doped | Y₂O₃:Eu | Optics |
| yttria | | |
| Terbia doped | Y₂SiO₅:Tb | Optics |
| yttrium silicate | | |
| | SrTiO₃:Pr | Optics |
| | Zn₂SiO₄:Mn | Optics |
| | (Y_{(1-x-y)}YbₓRe_{y})₂O₃ | Optics |

The nanoparticulates that are made using the method of the present invention may advantageously be made with a specific combination of sizes and properties for use in a desired application. For example, for applications such as pigments, metals for electronics, ceramic green bodies, some solid oxide fuel cells and phosphors, the nanoparticulates may preferably be made spheroidal, dense with a larger weight average particle size. For applications such as transparent coatings, some solid oxide fuel cells, inks (for methods of preparing and using inks comprising nanoparticles see, e.g., U.S. Provisional Application Ser. Nos. 60/643,577; 60/643,629; and 60/643,378, all filed on Jan. 14, 2005, the entireties of which are all incorporated herein by reference; and U.S. patent application Ser. No. 11/117,701, filed Apr. 29, 2005; Ser. No. 11/199,512, filed Aug. 8, 2005; and Ser. No. 11/199,100, filed Aug. 8, 2005, the entireties of which are incorporated herein by reference), chemical-mechanical polishing, catalysis and taggants/security printing the nanoparticulates may preferably be made to be spheroidal, dense and with a smaller weight average particle size less. As another example, the nanoparticulates may be made as agglomerates (hard or soft), with the nanoparticulates preferably having a larger or a smaller weight average particle size, depending upon the application. For applications such as transparent conductors, rheology additives (e.g., thickeners, flow indicators), chemical-mechanical planarization (CMP), security printing taggants, catalysis, optical applications, cosmetics, and applications involving electrical conductivity the nanoparticulates may in some embodiments be made in the form of agglomerates of the nanoparticulates.

The foregoing are just some nonlimiting examples of materials, properties and applications of use for which the nanoparticulates may be designed. It should be understood that the nanoparticulates formed with the method of the present invention may have a variety of applications in other areas as well, and consequently be made with materials and/or properties, different from or in a different combination than those noted above.

With reference again to FIG. 1, as noted in one preferred implementation the nongaseous precursor is in a nongaseous disperse phase during the introducing 100. The disperse phase may be for example, in the form of droplets or particles. The term “droplet” used in reference to such a disperse phase refers to a disperse domain characterized as including liquid (often the droplet is formed solely or predominantly of liquid, although the droplet may comprise multiple liquid, phases and/or particles suspended in the liquid). The term “particle” used in reference to such a disperse phase refers to a disperse domain characterized as being solid. The term “solid” is in relation to such particles not used in a technical material property sense to denote crystalline structure, but rather that the material is hard and substantially not flowable. Such “solid” materials may be amorphous.

In the case of droplets, the liquid may include one or more than one of any of the following liquid phases: organic, aqueous, and organic/aqueous mixtures. In addition to one or more liquid phase, the droplets may also contain one or more than one type of solid particulate. Some nonlimiting examples of organic liquids that may be included in the droplets include alcohols (e.g., methanol, ethanol, isopropanol, butanol), organic acids, glycols, aldehydes, ketones, ethers, waxes, or fuel oils (e.g., kerosene or diesel oil). In addition to or instead of the organic liquid, the liquid in the disperse phase may include an inorganic liquid, which will typically be aqueous-based. Some nonlimiting examples of such inorganic liquids include water and aqueous solutions, which may be pH neutral, acidic or basic. A liquid of the droplets may include a mixture of mutually soluble liquid components, or the droplets may contain multiple distinct liquid phases (e.g., an emulsion). Liquid in droplets may be a mixture of two or more mutually soluble liquid components. For example, a liquid phase could comprise a mixture of mutually soluble organic liquids or a mixture of water with one or more organic liquids that are mutually soluble with water (e.g., some alcohols, ethers, ketones, aldehydes, etc.). Droplets may also include multiple liquid phases, such as in an emulsion. For example, a droplet could include an oil-in-water or a water-in-oil emulsion. In addition to multiple liquid phases, the droplets may include multiple liquid phases and one or more solid phases (i.e., suspended particles). As one example, the droplets may include an aqueous phase, an organic phase and a solid particle phase. As another example, the droplets may include an organic phase, particles of a first composition and particles of a second composition.

Moreover, a liquid, or component thereof, in disperse phase droplets may have a variety of functions. For example, a liquid in the disperse phase may be a solvent for the nongaseous precursor, and the nongaseous precursor may be dissolved in the liquid when introduced into the flame reactor. As another example, a liquid in the disperse phase may be or include a component that is a fuel or an oxidant for combustion in a flame of the flame reactor. Such fuel or oxidant in the liquid may be the primary or a supplemental fuel or oxidant for driving the combustion in a flame. Liquid in the disperse phase may provide one or more of any of these or other functions.

As noted above, disperse phase droplets may comprise particles suspended in the liquid of the droplets. Such suspended particles may be or comprise the nogaseous precursor, a fuel or an oxidant, or may serve some other function, and the particles may comprise organic and/or inorganic constituents. As with the discussions above concerning fuel or oxidant in a liquid, fuel or oxidant in such suspended particulates may be primary or supplemental for combustion in a flame of the flame reactor.

When the disperse phase is disperse particles rather than disperse droplets, the disperse particles include the nongaseous precursor. Such disperse phase particles may also have one or more component serving another functions, such as for example a fuel and/or an oxidant for combustion in the flame, in the same manner as discussed above with respect to particles that may be suspended in droplets.

As previously stated, the disperse phase has a nongaseous precursor that includes a component for inclusion in the nanoparticulates, and the nongaseous precursor may be formulated in the disperse phase liquid and/or solid material for introduction into the flame reactor. In a preferred implementation, the nongaseous precursor is initially dissolved in a liquid medium and the liquid medium, which may contain suspended solids, is then atomized to form droplets and the droplets are then fed directly to the flame reactor or are predried to form particles that are then fed to the flame reactor. Some nonlimiting examples of classes of materials that may be used as the nongaseous precursor include: nitrates, oxalates, acetates, acetyl acetonates, carbonates, acrylates and chlorides.

Other examples of precursors for target materials in the nanoparticulates are disclosed in the U.S. Provisional Patent Application No. 60/599,847, referenced previously. When the nongaseous precursor is introduced into the flame reactor in a disperse phase, as discussed above, in one preferred embodiment the disperse phase is dispersed in a gas phase. The gas phase may include any combination of gas components in any concentrations. The gas phase may include only components that are inert (i.e. nonreactive) in the flame reactor or the gas phase may comprise one or more reactive components (i.e., decompose or otherwise react in the flame reactor). When nongaseous precursor is fed to a flame, the gas phase may comprise a gaseous fuel and/or oxidant for combustion in the flame. A nonlimiting example of a gaseous oxidant is gaseous oxygen, which could be provided by making the gas phase from or including air. A nonlimiting example of another possible gaseous oxidant is carbon monoxide. Nonlimiting examples of gaseous fuels that could be included in the gas phase include hydrogen gas and gaseous organics, such as for example C₁-C_{y} hydrocarbons (e.g., methane, ethane, propane, butane). Often, the gas phase will include at least oxidant (normally oxygen in air), and fuel will be delivered separately to the flame. Alternatively, the gas phase may include both fuel and oxidant premixed for combustion in a flame. Also, the gas phase may include a gas mixture containing more than one oxidant and/or more than one fuel. Also, the gas phase may include one or more than one gaseous precursor for a material of the nanoparticulates. Such a gaseous precursor(s) would be in addition to the nongaseous precursor in the disperse phase. The component provided by a gaseous precursor for inclusion in the nanoparticulates may be the same or different than the component provided by the nongaseous precursor. One situation when the gas phase often includes a gaseous precursor is when making nanoparticulates including an oxide material, and the gaseous precursor is oxygen gas. Sufficient oxygen gas must be included, however, to provide excess over that consumed by combustion when the nogaseous precursor is fed to the flame. Moreover, the gas phase may include any other gaseous component that is not inconsistent with manufacture of the desired nanoparticulates, or that serves some function other than those noted above.

As noted previously, the flame reactor includes one or more than one flame that directly heats an interior reactor volume. Each flame of the flame reactor will typically be generated by a burner, through which oxidant and the fuel are fed to the flame for combustion. The burner may be of any suitable design for use in generating a flame, although the geometry and other properties of the flame will be influenced by the burner design. Some exemplary burner designs that may be used to generate a flame for the flame reactor are discussed below. Each flame of the flame reactor may be oriented in any desired way. Some nonlimiting examples of orientations for the flame include horizontally extending, vertically extending or extending at some intermediate angle between vertical and horizontal. When the flame reactor has a plurality of flames, some or all of the flames may have the same or different orientations.

Each flame of the flame reactor will often be associated with an ignition source that ignites the oxidant and fuel to generate the flame. In some instances, the ignition source will be one or more pilot flames that in addition to providing an initial ignition source to start the combustion of the oxidant and the fuel, may also provide a continual ignition/energy source that sustains the flame of the flame reactor. The pilot flame may be generated from the same oxidant and fuel used to generate the main flame, or from a different fuel and/or oxidant. For example, when using the same fuel, a pilot flame may be generated using a small stream of fuel flowing through one channel of a multi-channel burner used to generate a flame of the flame reactor. The small stream of fuel may be premixed with an oxidant or may consume oxygen from the ambient environment to generate the pilot flame. This is merely one example, and in other examples, the pilot flame may be generated using a separate burner. The ignition source is not limited to pilot flames, in some cases, the ignition source may be a spark or other ignition source.

Also, each flame has a variety of properties (e.g., flame geometry, temperature profile, flame uniformity, flame stability), which are influenced by factors such as the burner design, properties of feeds to the burner, and the geometry of the enclosure in which the flame is situated.

One important aspect of a flame is its geometry, or the shape of the flame. Some geometries tend to provide more uniform flame characteristics, which promotes manufacture of the nanoparticulates with relatively uniform properties. One geometric parameter of the flame is its cross-sectional shape at the base of the flame perpendicular to the direction of flow through the flame. This cross-sectional shape is largely influenced by the burner design, although the shape may also be influenced by other factors, such as the geometry of the enclosure and fluid flows in and around the flame. Other geometric parameters include the length and width characteristics of the flame. In this context the flame length refers to the longest dimension of the flame longitudinally in the direction of flow and flame width refers to the longest dimension across the flame perpendicular to the direction of flow. With respect to flame length and width, a wider, larger area flame, has potential for more uniform temperatures across the flame, because edge effects at the perimeter of the flame are reduced relative to the total area of the flame.

Discharge from each flame of the flame reactor flows through flow path, or the interior pathway of a conduit, through the flame reactor. As used herein, “conduit” refers to a confined passage for conveyance of fluid through the flame reactor. When the flame reactor comprises multiple flames, discharge from any given flame may flow into a separate conduit for that flame or a common conduit for discharge from more than one of the flames. Ultimately, however, streams flowing from each of the flames generally combine in a single conduit prior to discharge from the flame reactor.

A conduit through the flame reactor may have a variety of cross-sectional shapes and areas available for fluid flow, with some nonlimiting examples including circular, elliptical, square or rectangular. In most instances, however, conduits having circular cross-section are preferred. The presence of sharp corners or angles may create unwanted currents or flow disturbances that can aggregate deposition on conduit surfaces. Walls of the conduit may be made of any material suitable to withstand the temperature and pressure conditions within the flame reactor. The nature of the fluids flowing through the flame reactor may also affect the choice of materials of construction used at any location within the flame reactor. Temperature, however, may be the most important variable affecting the choice of conduit wall material. For example, quartz may be a suitable material for temperatures up to about 1200° C. As another example, for temperatures up to about 1500° C., possible materials for the conduit include refractory materials such as alumina, mullite or silicon carbide might be used. As yet another example, for processing temperatures up to about 1700° C., graphite or graphitized ceramic might be used for conduit material. As another example, if the flame reactor will be at moderately high temperatures, but will be subjected to highly corrosive fluids, the conduit may be made of a stainless steel material. These are merely some illustrative examples. The wall material for any conduit portion through any position of the flame reactor may be made from any suitable material for the processing conditions.

The nongaseous precursor is introduced into the flame reactor in a very hot zone, also referred to herein as a primary zone, that is sufficiently hot to cause the component of the nongaseous precursor for inclusion in the nanoparticulates to be transferred through the gas phase of a flowing stream in the flame reactor, followed by a particle nucleation from the gas phase. Typically the temperature in at least some portion of this primary zone, and sometimes only in the hottest part of the flame, is high enough so that substantially all of materials flowing through that portion of the primary zone is in the gas phase. The component of the nongaseous precursor may enter the gas phase by any mechanism. For example, the nongaseous precursor may simply vaporize, or the nongaseous precursor may decompose and the component enters the gas phase as part of a decomposition product. Eventually, however, the component leaves the gas phase as particle nucleation and growth occurs. Removal of the component from the gas phase may involve simple condensation as the temperature cools or may include additional reactions involving the component that results in a non-vapor reaction product. In addition to this primary zone where the component of the nongaseous precursor is transferred into the gas phase, the flame reactor may also include one or more subsequent zones for growth or modification of the nanoparticulates. In most instances, the primary zone will be the hottest portion within the flame reactor.

With reference to FIG. 2, one embodiment of a flame reactor that may be used with the method of the present invention is shown. FIG. 2 is a cross-sectional view of a flame reactor 106. Flame reactor 106 includes a tubular conduit 108 of a circular cross-section, a burner 112, and a flame 114 generated by the burner 112. In the embodiment of FIG. 2, flame 114 is disposed within tubular conduit 108. Flame reactor 106 has a very hot primary zone 116 that includes the flame 114 and the internal reactor volume within the immediate vicinity of the flame.

Also, shown in FIG. 2, is feed 120 including the nongaseous precursor introduced directly into the flame 114 through the burner 120. Fuel and oxidant for the flame 114 may be fed to the flame 114 as part of and/or separate from the feed 120 of the nongaseous precursor.

FIGS. 3 and 4 show the same flame reactor 106, except with feed of the nongaseous precursor introduced into the primary zone 116 in different locations. In FIG. 3, feed of nongaseous precursor 122 is introduced in the primary zone 116 directed toward the end of the flame 114, rather than through the burner 112 as with FIG. 1. In FIG. 4, feed of nongaseous precursor 126 is introduced into the primary zone 116 at a location adjacent to, but just beyond the end of the flame 114.

FIGS. 2-4 are only examples of where nongaseous precursors may be introduced into a flame reactor. Additionally multiple feeds of precursor may be introduced into the flame reactor 106, with different feeds being introduced at different locations, such as simultaneous introduction of the feeds 120, 122 and 126 of FIGS. 2-4.

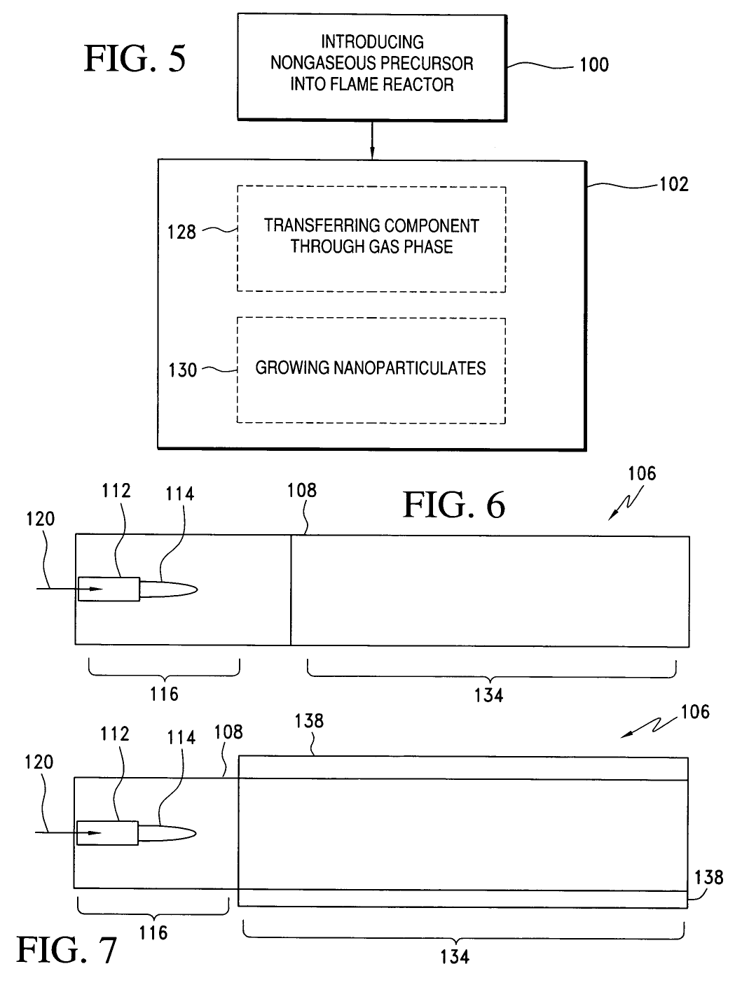

Referring again to FIG. 1, the nanoparticulates are formed during the forming 102. As noted previously, to form the desired nanoparticulates, including the component from the nongaseous precursor, the component is transferred through the gas phase in the flowing stream in the flame reactor. Following nucleation of the particles, the particles must then grow to the desired size. With reference now to FIG. 5, a generalized process-block diagram is shown of one embodiment of the method of the present invention. As in FIG. 1, the process includes the steps of introducing 100 the nongaseous precursors into the flame reactor and the forming 102 particles. In FIG. 5, the forming 102 is shown to include both transferring 128 the component of the nongaseous precursor through the gas phase 128 and a growing 130 the nanoparticulates to attain the desired size.

During the transferring 128, the component of the nongaseous precursors, and typically all other material of the nongaseous precursor, enters the gas phase in a vapor form. The transfer into the gas phase is driven by the high temperature in the flame reactor in the vicinity of where the nongaseous precursor is introduced during the introducing 100. As previously noted, this may occur by any mechanism, including simple vaporization of the nongaseous precursor or thermal decomposition or other reaction involving the nongaseous precursor. The transferring 128 also includes removing the component from the gas phase, to permit inclusion in the nanoparticulates. Removal of the nongaseous precursor from the gas phase may likewise involve a variety of mechanisms, including simple condensation as the temperature of the flowing stream drops, precipitation due to high concentration in the gas phase, or a reaction producing a reaction to a non-volatile reaction product. Also, it is noted that transfer into and out of the gas phase are not necessarily distinct steps, but may be occurring simultaneously, so that some of the component may still be transferring into the gas phase where other of the component is already transferring out of the gas phase. Regardless of mechanism, however, substantially the entire component from the nongaseous precursor is transferred through the gas phase during the transferring 128.

In one example, the nongaseous precursor may be a solid material that includes the component. The temperature in the flame reactor may be above the boiling point of the precursor material. Consequently, the transferring component 128 may involve simple vaporization of nongaseous precursor. In one specific example, the precursor may be a solid or liquid metal, and the metal is the component for inclusion in the nanoparticulates. In the flame reactor the metal may then vaporize in the high temperature zone of the flame reactor following introduction and then condense out as the stream cools. The temperature in the flame reactor may be above the boiling point of silver, so that the silver introduced as a solid in the flowing stream will boil and be included in the gas phase as silver vapor, prior to be being included in the nanoparticulates. Thus, the transferring the component 128 may merely involve boiling or vaporizing a solid precursor into a vapor. In another example, a solid or liquid precursor including the component may react or decompose to form a reaction product, either a vapor-phase material or one that is vaporized following formation.

Also, substantially all material in a feed stream of the nongaseous precursor should in one way or another be transferred into the gas phase during the transferring 128. For example, one common situation is for the feed to include droplets in which the nongaseous precursor is dissolved when introduced into the flame reactor. In this situation, liquid in the droplet must be removed as well. The liquid may simply be vaporized to the gas phase, which would typically be the case for water. Also, some or all of the liquid may be reacted to vapor phase products. As one example, when the liquid may contain fuel or oxidant that is consumed by combustion in a flame in the reactor, likewise, any solid fuel or oxidant in the feed would also be consumed and converted to gaseous combustion products.

Referring again to FIG. 5, in addition to the transferring 128, the forming 102 also includes the growing 130 nanoparticulates. During the growing 130, the nanoparticulates are controllably grown to increase the weight average particle size of the nanoparticulates into a desired weight average particle size range, which will depend upon the particular composition of the nanoparticulates and the particular application for which the nanoparticulates are being made.

The growing commences with particle nucleation and continues until the nanoparticulates attain a weight average particle size within a desired range. When making extremely small particles, the growing 130 may mostly or entirely occur within the primary zone of the flame reactor immediately after the flame. However, when larger particle sizes are desired, processing may be required in addition to that occurring in the primary zone of the flame reactor. As used herein, “growing” the nanoparticulates refers to increasing the weight average particle size of the nanoparticulates. Such growth may occur due to collision and agglomeration of smaller particles into larger particles or through addition of additional material into the flame reactor for addition to the growing nanoparticulates. The growth of the nanoparticulates may involve added material of the same type as that already present in the nanoparticulates or addition of a different material.

As noted in some embodiments an important contribution to the growing 130 is due to collisions between similar particles and agglomeration of the colliding particles to form a larger particle. The agglomeration must be sufficiently complete that the colliding particles fuse together to form a new larger primary particle, with the prior primary particles of the colliding particles no longer being present. Agglomeration to this extent will often involve significant sintering to fuse the colliding particles. An important aspect of the growing 130 within the flame reactor is to control conditions within the flame reactor to promote the desired collision and fusing of particles following nucleation.

In other embodiments, the growing 130 may occur or be aided by adding additional material to the nanoparticulates following nucleation. In this situation, the conditions of the flame reactor are controlled so that the additional material is added to the nanoparticulates to increase the weight average particle size of the nanoparticulates into the desired range. Growth through addition of additional material is described in more detail below. In some embodiments, the growing 130 may involve both collision/agglomeration and material additions.

During the growing 130, the nanoparticulates are typically grown to a weight average particle size in a range having a lower limit selected from the group consisting of 1 nm, 5 nm, 10 nm, 20 nm, 40 nm, 50 nm, 60 nm, 70 nm, 80 nm, 90 nm, 100 nm, 125 nm and 150 nm and an upper limit selected from the group consisting of 10 nm, 20 nm, 30 nm, 40 nm, 50 nm, 60 nm, 70 nm, 80 nm, 90 nm, 100 nm, 125 nm, 150 nm, 200 nm, 250 nm, 300 nm, 400 nm and 500 nm; provided that the upper limit is selected to be larger than the lower limit.

Especially when making larger nanoparticulates it is important to provide sufficient residence time at sufficiently high temperature to permit the desired particle growth. These larger-size nanoparticulates are desirable for many applications, because the larger-size nanoparticulates are often easier to handle, easier to disperse for use and more readily accommodated in existing product manufacturing operations. By larger-size nanoparticulates it is generally meant those having a weight average particle size of at least 50 nm, more typically at least 70 nm and often at least 100 nm or even larger. Growing nanoparticulates to those larger sizes will generally require a controlled secondary zone in the flame reactor, because the particle size attainable in the primary zone is typically much smaller than the desired size. Also, it is important to emphasize again that the size of the nanoparticulates as used herein refer to the primary particle size of individual nanoparticulate domains, and should not be confused with the size of aggregate units of necked-together primary particles. Unless otherwise specifically noted, particle size herein refers only to the size of the identifiable primary particles.

One implementation of the embodiment of the method of the invention shown in FIG. 5, involves making relatively large-size nanoparticulates including a relatively low-melting temperature material. The low-melting temperature material preferably has a melting temperature that is less than about 2000° C. In some embodiments, the low-melting temperature material may have a melting temperature within a range having a lower limit selected from the group consisting of 200° C., 300° C., 400° C., 500° C., 600° C., 700° C., 800° C. and 900° C. and an upper limit selected form the group consisting of 2000° C., 1900° C., 1800° C. 1700° C., 1600° C., 1500° C., 1400° C., 1300° C., 1200° C., 1100° C. and 1000° C.

The nanoparticulates may be made entirely of the low-melting temperature material or the low-melting temperature material may be one of multiple phases when the nanoparticulates are multi-phase nanoparticulates. Also, the low-melting temperature material may be any material having a melting temperature within a desired range. The low-melting temperature materials may be metal or ceramic and maybe organic or inorganic, although inorganic materials are generally preferred. Some examples of metals that are low-melting temperature materials that may be processed with this implementation of the invention (and their melting temperatures) include: silver, gold, copper, nickel, chromium, zinc, antimony, barium, cesium, cobalt, gallium, germanium, iron, lanthanum, magnesium, manganese, palladium, platinum, uranium, strontium, thorium, titanium and yttrium and alloys (including intermetallic compounds) of any number of the foregoing. Other metal alloys (including intermetallic compounds) including a metal component with a higher melting temperature may nevertheless also have melting temperatures applicable for processing according to this implementation of the invention (e.g., including many eutectic compositions). Some examples of ceramics that are low-melting temperature materials and may be processed with this implementation of the invention include: some oxides, such as tin oxides, indium tin oxide, antimony tin oxide and molybdenum oxides; some sulfides, such as zinc sulfide; and some silicates, such as borosilicate glasses. Also, a number of metal alloys and intermetallic compositions including one or more of these metals have low melting temperatures and are processible with this implementation of the invention.

Made according to this implementation of the invention may be multi-phase, or composite nanoparticulates that comprise only low-melting temperature materials in different phases or that include at least one low-melting temperature material phase and also one or more high-melting material such as having a melting temperature greater than 2000° C. in one or more other phases.

At least a portion of the growing 130 will typically be performed in a volume of a flame reactor downstream from the primary zone that is better suited for controllably growing nanoparticulates to within the desired weight average particle size range. This downstream portion of the flame reactor nanparticulates is referred to herein as a secondary zone to conveniently distinguish it from the primary zone discusses above.

FIG. 6 shows an embodiment of flame reactor 106 previously described with respect to FIGS. 2-4 that also has an identified secondary zone 134 for aiding growth of the nanoparticulates to attain a weight average particle size within the desired range. As shown in FIG. 6, the secondary zone is a volume within conduit 108 that is downstream from the primary zone 116. The secondary zone 134 will typically be longer and occupy more of the internal reactor volume than the primary zone 116, and the residence time in the secondary zone 134 would typically be significantly larger than in the primary zone 116.

The embodiment of flame reactor 106 shown in FIG. 6 is merely one example of a flame reactor for use with performing the method of the present invention. In other embodiments, the primary zone and the secondary zone may be within different conduit configurations or within different equipment or apparatus in fluid communication. Additionally, as further described below, the primary zone and the secondary zone may be separated by other processing zones such as a quench zone and/or a particle modifying zone, described in more detail below.

With reference to FIG. 5 and FIG. 6, the following is a description of how the method as shown in FIG. 5 may be performed using the flame reactor 106 as shown in FIG. 6. During the introducing, feed 120 of nongaseous precursor is introduced into primary zone 116 through burner 112. Oxidant and a fuel are also fed to the flame through burner 112 for combustion to maintain the flame 114. The oxidant and/or fuel may be fed to the burner 112 together with or separate from the feed of the nongaseous precursor 120. As shown in FIG. 5, forming 102 includes the transferring 128, and the temperature attained in the primary zone 116, such as in the flame 114, is sufficiently high so that substantially all material of the target component in the nongaseous precursor is transferred through the gas phase, and nucleation then at least begins in primary zone 116. As the flowing stream in the flame reactor 106 exits the primary zone 116 and enters secondary zone 134, the nanoparticulates are growing. In secondary zone 134, conditions are maintained that promote continued growth of the nanoparticulates to a large size within the desired weight average particle size range.

As noted previously, the residence time in the secondary zone will typically be much longer than the residence time in the primary, or hot zone. By the term “residence time” it is meant the length of time that the flowing stream, remains within a particular zone (e.g., primary zone or secondary zone) based on the average stream velocity through the zone.

The residence time within the primary zone is generally less than one second, and more typically significantly less. Often the flowing stream has a residence time in the primary zone (and also the flame) in a range having a lower limit selected from the group consisting of 1 ms, 10 ms, 100 ms, and 250 ms and an upper limit selected from the group consisting of 500 ms, 400 ms, 300 ms, 200 ms and 100 ms, provided that the upper limit is selected to be larger than the lower limit. The residence time within the secondary zone will typically be at least twice as long, four times as long, six times or ten times as long as the residence time in the primary zone (and also as the residence time in the flame). Often, the residence time in the secondary zone is at least an order of magnitude longer than the residence time in the primary zone. The residence time of the flowing stream in the secondary zone is often in a range having a lower limit selected from the group consisting of 50 ms, 100 ms, 500 ms, 1 second and 2 seconds and an upper limit selected from the group consisting of 1 second, 2 seconds, 3 seconds, 5 seconds and 10 seconds, provided that the upper limit is selected to be larger than the lower limit. In the foregoing discussion, it should be understood that the residence times discussed above with respect to the flowing stream through the secondary zone would also be the residence time of the nanoparticulates in the secondary zone, since the nanoparticulates are within the flowing stream. The total residence for both the primary zone and the secondary zone is typically in a range having a lower limit selected from the group consisting of 100 ms, 200 ms, 300 ms, 500 ms and 1 second and an upper limit selected from the group consisting of 1 second, 2 seconds, 3 seconds, 5 seconds and 10 seconds, provided that the upper limit is selected to be larger than the lower limit.

In determining an appropriate residence time of the nanoparticulates in the secondary zone there are several considerations. Some of the considerations include the desired weight average particle size, the melting temperature (and sintering temperature) of materials in the nanoparticulates, the temperature within the secondary zone, residence time in the secondary zone and the volume concentration of the nanopaticulates in the flowing stream (volume of nanoparticulates/volume of per unit volume of the flowing stream).

With respect to the volume concentration of nanoparticulates flowing through the secondary zone, if such volume concentration is sufficiently large, then the nanoparticulates will tend to collide more frequently providing greater opportunity for particle growth more quickly, requiring less residence time within the secondary zone to achieve a desired weight average particle size. Conversely, if the nanoparticulate concentration within the secondary zone is small, the collisions between nanoparticulates will be less frequent and particle growth will necessarily proceed more slowly. Moreover, there is a particular volume concentration of nanoparticulates, referred to herein as a “characteristic volume concentration,” below which particle collisions become so infrequent that for practical purposes the nanoparticulates effectively stop growing due to particle collisions. Another way of describing the characteristic volume concentration of nanoparticulates is that it is the minimum volume concentration of nanoparticulates in the secondary zone that is necessary from a practical perspective to achieve a particular weight average particle size for the nanoparticulates through collisions in a residence time that is reasonably practical for implementation in a flame reactor system. The characteristic volume concentration will be different for different weight average particle sizes.

The volume concentration of nanoparticulates within the secondary zone may be at any appropriate volume concentration, provided that the volume concentration should at least be as large as the characteristic volume concentration for the minimum weight average particle size desired for at least some period of time during the growing in the secondary zone in the flame reactor.

As will be appreciated, unless the temperature of the flowing stream is maintained at a constant level through the entire secondary zone, the volume concentration of the particles in the flowing stream will change as the gas volume expands and contracts with changing temperature. For example, when the temperature of the flowing stream is lowest at the end of the secondary zone, the flowing stream will typically attain its highest volume density of nanoparticulates, which should preferably be at least as large as the characteristic volume density for the desired minimum weight average particle size. However, even though the volume concentration of nanoparticulates generally increases with decreasing temperature, it is important that when the volume concentration is above the characteristic volume concentration, that the temperature in the secondary zone is also high enough so that when particle collisions occur, the particles are likely to quickly fuse together, as discussed in more detail below.

If the temperature within the secondary zone is set to promote the growth of the nanoparticulates through collisions of the nanoparticulates (i.e. high enough for colliding particles to fuse to form a single nanoparticulate), then control of the volume concentration of the nanoparticulates and residence time in the secondary zone are the two most important control variables. Thus, if the volume concentration of nanoparticulates in the secondary zone is maintained at a specific concentration, then the residence time within the secondary zone will be changed in order to achieve the desired extent of collisions to achieve a weight average particle size in a desired range. However, if the residence time is set, then the volume concentration of nanoparticulates within the secondary zone may be controlled so that the desired weight average particle size is achieved within the set residence time. Control of the weight average particle size may be achieved for example by changing the temperature in the secondary zone and changing the concentration of the precursor in feed to the primary zone, or a combination of the two. Conversely, for a set residence time and temperature profile in the secondary zone, the concentration of nongaseous precursors (and other precursors) fed to the primary zone may be adjusted to achieve a desired volume concentration in the secondary zone to achieve at least the characteristic volume concentration for a desired weight average particle size.

Temperature control in the secondary zone of the flame reactor is very important. Maintaining the temperature of the secondary zone within a specific elevated temperature range may include retaining heat already present in the flowing stream (e.g., residual heat from the flame in the primary zone). This may be accomplished, for example, by insulating all or a portion of the conduit through the secondary zone to reduce heat losses and retain a higher temperature through the secondary zone. In addition to or instead of insulating the secondary zone, heat may be added to the secondary zone to maintain the desired temperature profile in the secondary zone.

The temperature in the secondary zone is maintained below a temperature at which materials of the nanoparticulates would vaporize or thermally decompose, but above a sintering temperature of the nanoparticulates. By “sintering temperature” it is meant a minimum temperature, at which colliding nanoparticulates sticking together will fuse to form a new primary particle within the residence time of the secondary zone. The sintering temperature of the nanoparticulates will, therefore, depend upon the material(s) in the nanoparticulates and the residence time of the nanoparticulates in the secondary zone. In those embodiments where the growing the nanoparticulates includes significant growth through particle collisions, the nanoparticulates should be maintained at, and preferably above, the sintering temperature in the secondary zone.

When the nanoparticulates are multi-phase particles, the “sintering temperature” of the nanoparticulates will vary depending upon the materials involved and their relative concentrations. Typically, the sintering together will be dictated by the lowest melting temperature material so long as that material is sufficiently exposed at the surface of colliding particles to permit the low-melting temperature domains to fuse to an extent to result in a new primary particle through the action of the lower-melting temperature material.

In a variation of the present invention, the nanoparticulates are maintained through at least a portion of, and perhaps the entire secondary zone, at or above a melting temperature of at least one material in the nanoparticulates, promoting rapid fusing and formation of a new primary particle. In another variation, the nanoparticulates are maintained, through at least a portion of and perhaps the entire secondary zone, at a temperature that is within some range above or below the melting temperature of at least one material of the nanoparticulates. For example, the temperature of the flowing stream through at least a portion of the secondary zone may be within a temperature range having a lower limit selected from the group consisting of 300° C. above the melting temperature of the material, 200° C. above the melting temperature of the material and 100° C. above the melting temperature and having a lower limit selected from the group consisting of 300° C. below the melting temperature of the material, 200° C. below the melting temperature of the material and 100° C. below the melting temperature of the material, provided that the upper limit must be selected to be below a vaporization temperature of the material and below a decomposition temperature of the material where the material decomposes prior to vaporizing. In a further variation, the temperature of the flowing stream in the secondary zone does not exceed a temperature within the selected range. As used herein, the temperature in the secondary zone and the stream temperature in the secondary zone are used interchangeably and refer to the temperature in the stream in the central portion of a cross-section of the conduit. As will be appreciated, the flowing stream will have a temperature profile across a cross-section of the flow at any point, with the temperature at the edges being higher or lower than in the center of the stream depending upon whether there is heat transfer into or out of the conduit through the wall.

In one variation, when processing glassy materials, the temperature through some portion of or through the entire secondary zone may be within some range of the softening temperature of the glassy materials—e.g., within 250° C. of the softening temperature. By the phrase “within 250° C. of the softening temperature” it is meant all of the temperatures that are in the range that has a minimum of 250° C. below the softening temperature of the glassy material included in the nanoparticulates and a maximum of 250° C. above the softening temperature of the glassy material included in the nanoparticulates. In this implementation, for example, the temperature through at least a portion of the secondary zone may be in a range having an upper limit selected from the group consisting of 200° C. above the softening temperature, 150° C. above the softening temperature, 100° C. above the softening temperature and a lower limit selected form the group consisting of 200° C. below the softening temperature, 150° C. below the softening temperature, 100° C. below the softening temperature and 50° C. below the softening temperature.

FIG. 7 shows an embodiment of flame reactor 106 which in addition to the parts previously described above with respect to FIGS. 2-4 and 6, includes an insulator 138 which surrounds and insulates the portion of the conduit 108 that includes the secondary zone 134. The insulator 138 is used to reduce heat transfer out of the flowing stream in secondary zone 134. Enhanced retention of heat in the secondary zone allows the nanoparticulates in the flowing stream to be maintained at higher temperatures in the secondary zone than if insulator 138 had not been used.

Insulator 138 may be made of any material or combination of materials and have any structure that provides a desired level of insulation. Some examples of materials for use in the insulator 138 include those materials described above with respect to the construction of the conduit through the flame reactor. For example, the insulation may comprise a refractory material such as alumina, silica and zirconia.

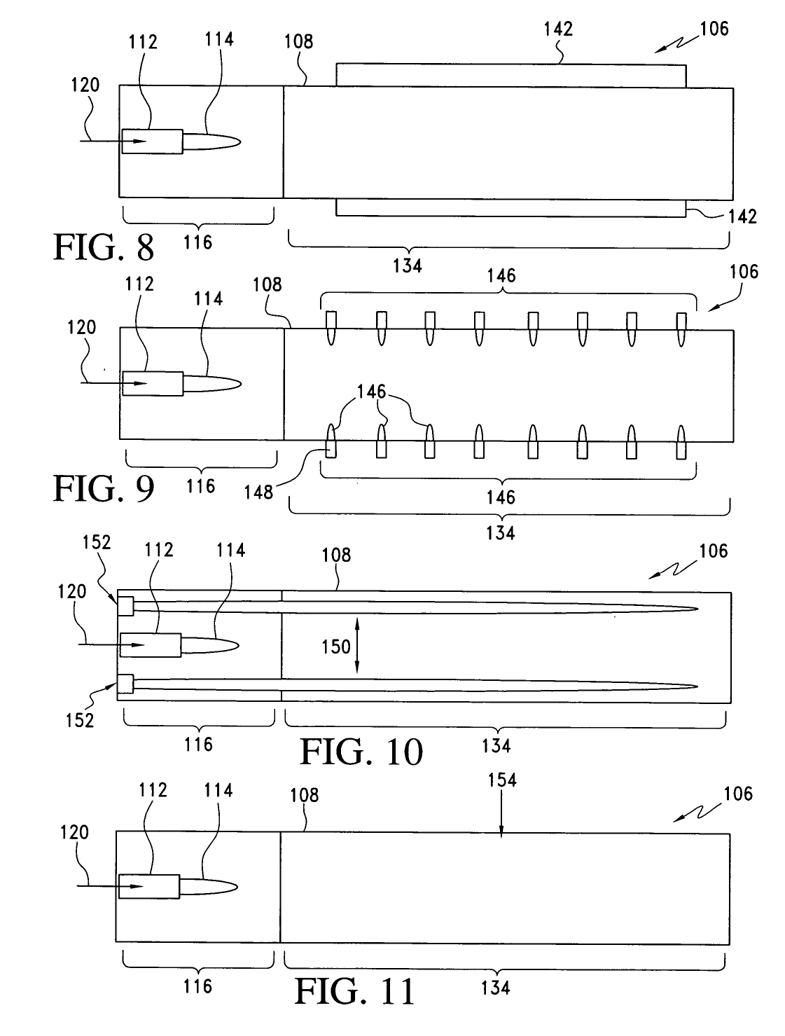

FIG. 8 shows one embodiment of flame reactor 106 that, in addition to the previously described parts, includes heater 142. Heater 142 is used to input heat into the flowing stream while the flowing stream is within secondary zone 134. The additional heat added to the secondary zone 134 by heater 142, provides control to maintain the nanoparticulates at an elevated temperature in the secondary zone that is higher than would be the case if the heater 142 were not used. The heater 142 may be any device or combination of devices that provides heat to the flowing stream in the secondary zone. For example, the heater 142 may include one or more flames or may be heated by a flame or a circulating heat transfer fluid. In one embodiment, the heater includes independently controllable heating zones along the length of the secondary zone 134, so that different subzones within the secondary zone 134 may be heated independently. This could be the case for example, when the secondary zone is a hot wall tubular furnace including multiple independently controllable heating zones.

FIG. 9 shows another embodiment of flame reactor 106 that includes a plurality of side flames 146 that add additional heat to the flowing stream while the flowing stream is in the secondary zone 134. Plurality of flames 146 are formed by combustion of an oxidant and a fuel fed through burners 148. The oxidant and the fuel combusted to form the plurality of flames 146 may be the same oxidant and fuel introduced into burner 112 and used to form flame 114, or alternatively, the oxidant and fuel used to generate the plurality of flames 146 may be different than the oxidant and the fuel used to form flame 114. Also, one or more of the side flames 146 may be lit while one or more other of the side flames 146 are not lit to provide more flexibility over temperature control in different portions of the secondary zone 134.

The plurality of burners 148 may be similar to burner 112 used to form flame 114, or may be different, but will typically be much smaller than the burner 112. The plurality of burners 148 are preferably spaced all around the perimeter of the conduit 108 to more uniformly introduce heat into secondary zone 134. For example, the burners 148 may be ring burners that are periodically spaced along the length of conduit 108 on the secondary zone 134. In other instances, the burners 148 are spaced around the perimeter and along the length of conduit 108 in a desired pattern around the perimeter of conduit 108. In yet another example, the burners 148 may be ribbon burners aligned along the length of conduit 108 and spaced periodically around the perimeter of conduit 108, other designs are also possible for the burners 148.

FIG. 10 shows an additional embodiment of flame reactor 106 that includes a plurality of flames 150 that are arranged around the interior perimeter of conduit 108. The flames 150 are generated by plurality of burners 152. The flames 150 are elongated and extend adjacent a wall of conduit 108 into the secondary zone. Similar to the plurality of flames 146 discussed above, plurality of flames 150 introduce additional heat into the flowing stream in both the primary zone 116 and the secondary zone 134 in the embodiment shown in FIG. 10. The fuel and oxidant used to generate plurality of flames 150 may be the same or different as the oxidant and the fuel used to form flame 114. The description above with respect to the fuel and oxidant used to form flames 142 also applies to flames 150. As an alternative to the use of the plurality of burners 150, a similar effect could be achieved by using a single ring burner instead of the burners 152.

FIGS. 8-10 are merely some exemplary embodiments of a flame reactor, including additional features to assist control of the temperature in the secondary zone 134 to help control the growing 130 (FIG. 5). Other flame reactor designs beside those disclosed in FIGS. 8-10 may be used including other temperature control features in addition to or instead of one or more of the features shown in FIGS. 8-10.

With reference again to FIG. 5, in some embodiments, the growing 130 includes adding additional material to the nanoparticulates (other than by collision/agglomeration) to increase the weight average particle size into a desired size range. The additional material may be the same or different than the material resulting from the nongaseous precursor discussed above.

When the additional material includes the same component as the component provided by the nongaseous precursor, discussed above, the additional amount of the component added to the nanoparticulates may be derived from addition of more of the nongaseous precursor or from a different precursor or precursors. Moreover, the additional material added to the nanoparticulates may result from additional precursor or precursors introduced into the flame reactor separate in the primary zone and/or the secondary zone.

An additional precursor may be included into the flame reactor during the introducing 100 as part of a combined feed with the nongaseous precursor, discussed above, when the additional precursor is different than such nongaseous precursor. Alternatively, additional precursors may be introduced separately into the flame reactor into the primary and/or secondary zone.

The following includes a description of various embodiments of the present invention in which one or more than one additional precursor is added to the flame reactor.

FIG. 11 shows an embodiment of flame reactor 106 that includes a feed 154 introduced into the secondary zone 134. Feed 154 includes a precursor or precursors for material for growth of the nanoparticulates in the secondary zone during the growing 130 nanoparticulates (FIG. 5). The feed 154 may include liquids, solids, gases and combinations thereof. Each precursor in feed 154 may be in the form of a liquid (including a solute in a liquid) a solid, or a gas. For example, a precursor in feed 154 may be a liquid phase precursor (e.g., a liquid substance or dissolved in a liquid). The liquid precursor may be introduced into secondary zone 134 in disperse droplets. As another example, a precursor may be a solid precursor which may be introduced into the secondary zone 134 in the feed 154 as dry disperse particulates or particulates contained in droplets. In another example, a precursor may be gaseous and included in a gas phase of feed 154.

The feed 154 and precursor(s) contained therein may be introduced into secondary zone 134 in a variety of ways. For example, if the precursor is contained in a liquid or a solid, it may be introduced into the secondary zone 134 in a disperse phase (e.g., droplets or particles) dispersed in a gas phase of feed 154. In other cases, feed 154 may only include the precursor in a liquid or a solid form with no additional phases or materials (i.e., feed 154 may be liquid sprayed into the secondary zone or a solid particulate feed into the secondary zone 134 without the aid of a gas phase).

In one variation, feed 154 may be introduced into the secondary zone 134 through a burner and a flame generated by that burner. The heat from the flame may be used to vaporize or otherwise react a precursor in feed 154 as may be necessary for forming the material to promote growth of the nanoparticulates in the secondary zone 134.

The introduction of feed 154 into secondary zone 134 may occur at various locations within the secondary zone 134, rather than at only one location as shown in FIG. 11. The invention is not limited to introduction of a single feed as shown in FIG. 11. Different ones of a plurality (i.e., more than one) of feeds may be introduced at different locations along the secondary zone 134, and the different feeds need not be of the same composition or include the same precursor(s). For example, a feed may be introduced at the beginning of secondary zone 134 and another feed of additional material may be introduced near the middle of secondary zone 134. In another example, several feeds may be at spaced locations along the secondary zone 134. The invention is not limited to these variations, and other variations are possible.

Different feeds that may be introduced into the secondary zone 134 do not have to include precursor(s) to the same materials or materials for inclusion in the nanoparticulates. Precursor(s) to different materials in differed spaced feeds may be desirable, for example, to form sequences of layers of different materials on the nanoparticulates.

In one implementation of the embodiment of the present invention utilizing the flame reactor 106 shown in FIG. 11, feed 154 has a precursor to an additional material that is different than any material already contained in the nanoparticulates when the nanoparticulates exit the primary zone 116. This implementation may be useful for making nanoparticulates including two or more different materials that are preferably formed under different processing conditions. This embodiment is also useful form making multi-phase nanoparticulates when a particular morphology is desired. For example, the additional material added to the nanoparticulates in the secondary zone may form a coating on the nanparticulates to form nanoparticulates with a core/shell morphology.

In one variation, the different material formed and deposited on the nanoparticulates in the second zone aids growth of the nanoparticulates through enhancement of the fusability of colliding nanoparticulates. The different material added to the nanoparticulates may have, for example, a lower sintering and/or melting temperature than other material(s) in the nanoparticulates, and addition of this additional material on the exposed surface of the nanoparticulates will assist colliding particles to stick together and fuse to form a new primary particle. This is particularly the case if the temperature in secondary zone 134 is maintained at a temperature above the melting temperature of the additional material. The presence of liquid phase material exposed at the surface of the nanoparticulates will significantly aid the prospect that colliding particles will join together and form a new primary particle. This embodiment is particularly useful for growing nanoparticulates containing high-melting temperature material(s) that might not otherwise stick together and sufficiently sinter to form a new, larger primary particle.

With reference once again to FIG. 5, when the growing 130 includes growing the nanoparticulates through collisions, in one implementation the growth may be aided by the use of a fluxing material. By the term “fluxing material” or simply “flux”, which are used interchangeably herein, it is meant a material that promotes and aids in fusing, sintering or coalescing of two colliding nanoparticulates to form a new primary particle larger in size than either of the two colliding nanoparticulates. The previously described embodiment of adding an additional material to the nanoparticulates in secondary zone 154 that is of a lower melting temperature than other materials in the nanoparticulates is one example of the use of a fluxing material. However, the use of a fluxing material is not limited to that embodiment. For example, a fluxing material does not have to be a liquid or be in a liquid phase during the growing 130 in order to aid in growing the nanoparticulates. In some cases, the fluxing material may be a solid phase.

The fluxing material may be introduced into the flame reactor at any convenient location as long as the introduction and subsequent processing results in exposure of the fluxing material at the surface of the nanoparticulates through at least some portion of the secondary zone during the growing 130. As one example with reference to FIGS. 5 and 11, the fluxing material may be introduced as part of the flowing stream during the introducing 100 into primary zone 116. As another example, the fluxing material may be added into secondary zone 134, such as for example as part of feed 154 into the secondary zone during the growing 130. One advantage of introducing the fluxing material in feed 154 is the ability to controllably deposit the fluxing material on the outside of the nanoparticulates. The fluxing material should be introduced in such a manner and/or be of such a type that the fluxing material deposits on the surface of already formed nanoparticulates or through phase interaction in the nanoparticulates migrates to the surface of the nanoparticulates, so that it is will be available at the surface of the nanoparticulates to aid growth of colliding particles. The fluxing material does not, however, have to completely cover an outside surface of the nanoparticulates, but only needs to be exposed at over a sufficient portion of the surface to provide the growth aiding effect to colliding particles.

The specific type of fluxing material used in an embodiment of the present invention will depend on the materials included in the nanoparticulates. However, any material that will aid in sintering, coalescing, agglomerating or fusing nanoparticulates together may be used with the present invention. One example of a class of materials that are useful as fluxing material include salts, such as alkali metal halides, with some nonlimiting specific examples including potassium chloride and sodium chloride. Salts are useful fluxing materials particularly when the nanoparticulates include phosphors such as Y₂O₃:Eu; Y₂O₂S doped with Eu and/or Tb; ZnS doped with Au, Al and Cu; ZnS doped with Ag or Cl; SrGa₂S₄ doped with Eu and/or Ce; Y₅(Ga,Al)₅O₁₂ doped with Tb or Cr; Zn₂SiO₄:Mn; and Y₂SiO₅ doped with Tb or Ce.

Although the use of a fluxing material may be used in the manufacture of nanoparticulates of any composition, the technique is especially useful in the manufacture of nanoparticulates that include high-melting temperature material(s). Nanoparticulates containing only high-melting temperature material(s) are difficult to maintain at a high enough temperature for a long enough time for adequate sintering to obtain significant particle growth through the collision route. Rather, such nanoparticulates tend to either not agglomerate at all or form only agglomerate units of small primary particles joined by necking. Thus, they must be maintained at high temperatures for long residence times to obtain any significant particle growth after exiting the flame. In some cases the necessary residence times may be impractical within a flame reactor. With the use of a fluxing material, however, larger nanoparticulates containing the high-melting temperature material(s) may be formed.

High-melting temperature materials, which may be processed with use of a fluxing material include high-melting temperature metals and ceramics. The high melting temperature material may have a melting temperature of at least as high as or higher than a temperature selected from the group consisting of 1800° C., 1900° C., 2000° C., and 2200° C., but generally lower than 3000° C. or even lower than 2500° C. Some examples of metals that may be considered high-melting temperature materials include boron, chromium, hafnium, iridium, molybdenum, niobium, osmium, rhenium, ruthenium, tantalum, tungsten and zirconium. Some classes of ceramics that include materials that may be considered as being high-melting temperature materials include oxides; nitrides, carbides, tellurides, selinides, titanates, tantalates and glasses.

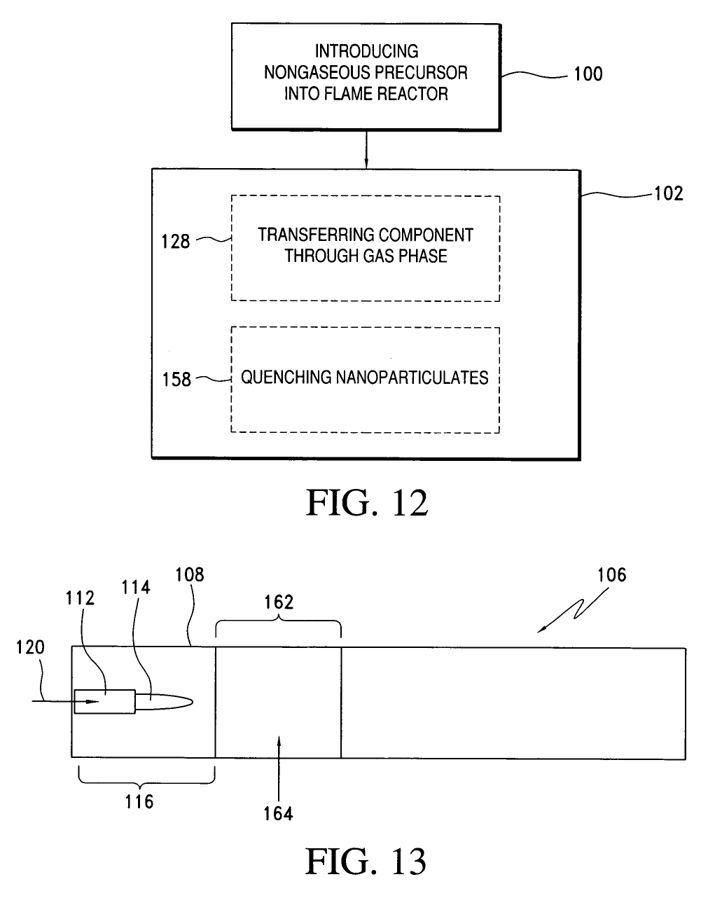

FIG. 12 shows a generalized block diagram of another embodiment of the method of the present invention for making nanoparticulates. As shown in FIG. 12, the forming 102 includes quenching 158, during which the nanoparticulates are quenched to reduce their temperature. The quenching 158 involves reducing the temperature of the nanoparticulates by mixing into the flowing stream in the flame reactor a quench gas. The quench gas used to lower the temperature of the nanoparticulates is at a lower temperature than the flowing stream, and when mixed with the flowing stream it reduces the temperature of the flowing stream, and consequently also the nanoparticulates in the flowing stream. The quenching 158 may reduce the temperature of the nanoparticulates by any desired amount. For example, the temperature of the flowing stream may be reduced by an amount of at least a value selected from the group consisting of 10° C., 25° C., 50° C., 100° C., 200° C., 300° C., 500° C., 600° C., 700° C., 800° C., 900° C., 1000° C., 1200° C. and 1500° C. As another example, the temperature of the flowing stream may be reduced by an amount not larger than a value selected from the group consisting of 100° C., 200° C., 300° C., 500° C., 600° C., 700° C., 800° C., 900° C., 1000° C., 1200° C., 1500° C., 2000° C. and 2500° C. Typically, however, the temperature of the flowing stream should not be cooled to a temperature at which contaminant materials would condense out of the gas phase in the flowing stream.

FIG. 13 shows one embodiment of the flame reactor 106 that may be used to implement the method shown in FIG. 12. In addition to a primary zone 116, flame reactor 106 includes a quench zone 162. The quench zone 162 is immediately downstream of the primary zone 116. A feed 164 of quench gas is introduced into quench zone 162 for mixing with the flowing stream. Mixing the cooler quench gas into the flowing stream reduces the temperature of the flowing stream and any nanoparticulates in the flowing stream.

The flame reactor 106 shown in FIG. 13 is only one embodiment of a flame reactor useful to implement the embodiment of the method shown in FIG. 12. The flame reactor 106 shown in FIG. 13 shows the quench zone as within a same conduit configuration as the primary zone 116. However, in other embodiments, the quench shown may be in a conduit portion having a different shape, diameter or configuration than the primary zone 116. One example of a quench system that may be used as a quench zone to implement the method of the present invention is disclosed in U.S. Pat. No. 6,338,809, the entire contents of which are hereby incorporated by reference as if set forth herein in full.

With reference again to FIG. 12, the quench gas used in the quenching 158 may be any suitable gas for quenching the nanoparticulates. The quench gas may be, nonreactive after introduction in the flame reactor and introduced solely for the purpose of reducing the temperature of the flowing stream. This might be the case for example, when it is desired to stop the growth of the nanoparticulates through further collisions. The quenching 158 helps to stop further growth by diluting the flowing stream, thereby decreasing the frequency of particle collisions, and reducing the temperature, thereby reducing the likelihood that colliding particles will fuse together to form a new primary particle. When it is desired to stop further particle growth, the cooled stream exiting the quenching 158 should preferably be below a sintering temperature of the nanopariculates. The cooled nanoparticulates may then be collected—i.e., separated from the gas phase of the flowing stream. The quenching 158 may also be useful in retaining a particular property of the nanoparticulates as they have formed and nucleated in the flowing stream. For example, if the nanoparticulates have nucleated and formed with a particular phase that is desirable for use in a final application, the quenching 158 may help to retain the desirable phase that would otherwise re-crystallize if not quenched. In other words, the quenching 158 may be useful to stop recrystallization of the nanoparticulates if it is desirable to retain a particular crystal structure that the nanoparticulates have nucleated and formed with. Alternatively, the quench gas may be non-reactive, but is not intended to stop nanoparticulate growth, but instead to only reduce the temperature to accommodate some further processing to occur at a lower temperature. As another alternative, the quench gas may be reactive in that it includes one or more components that is or becomes reactive in the flame reactor, such as reactive with material of the nanoparticulates or with some component in the gas phase of the flowing stream in the flame reactor. As one example, the quench gas may contain a precursor for additional material to be added to the nanoparticulates. The precursor may undergo reaction in the quench zone prior to contributing a material to the nanoparticulate, or may not undergo any reactions. In one specific example, the quench gas may contain oxygen, which reacts with a metal in the nanoparticulates to promote production of a metal oxide in the nanoparticulates.

In addition to a gas phase, a quench fluid introduced into the flame reactor may also include a nongaseous phase—e.g., a disperse particulate and/or disperse droplet phase. The nongaseous phase may have any one of a variety of functions. For example, a nongaseous phase may contain precursor(s) for material(s) to be added to the nanoparticulates. As another example, the quench gas may include a nongaseous phase that assists in lowering the temperature of the nanparticulates, such as water droplets included to help consume heat and lower the temperature as the water vaporizes after introduction into the flame reactor. Other nongaseous phases may be used to assist lowering the temperature by consumption of heat through vaporization, however water is often preferred because of its low cost and high latent heat of vaporization.

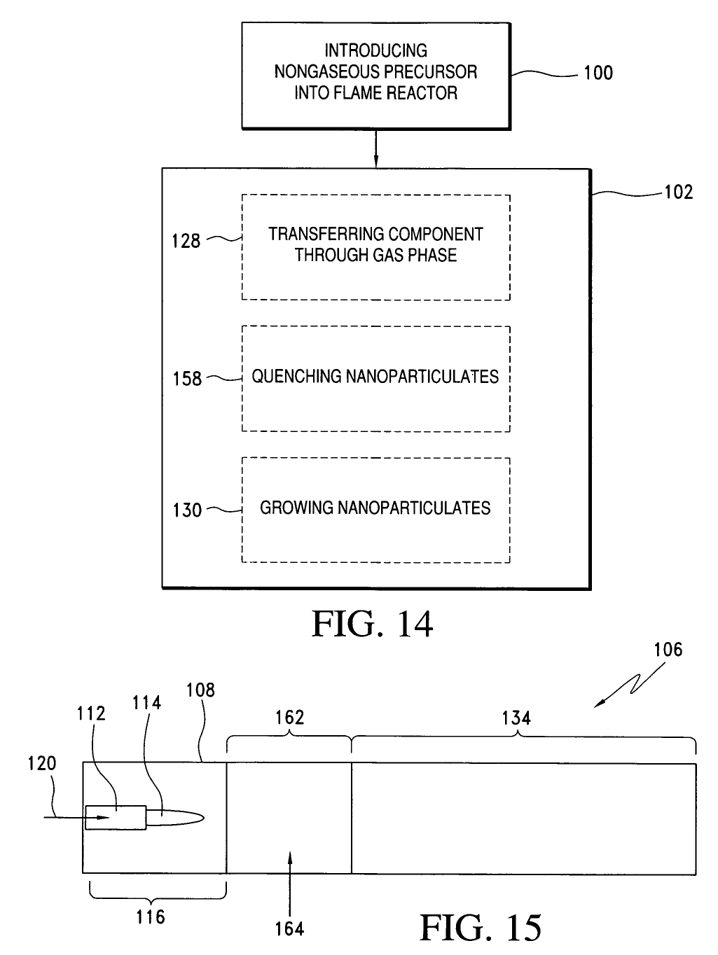

Additionally, a quench may also be combined with other processing steps. FIG. 14 shows a generalized process block diagram of another embodiment of the method of the present invention that includes the quenching 158 followed by the growing 130, which are each the same as discussed previously. Various embodiments of the method of the present invention shown in FIG. 14 are described below with respect to FIG. 15.

FIG. 15 shows one embodiment of a flame reactor that may be used to implement the method of the present invention shown in FIG. 14. FIG. 15 shows another embodiment of the flame reactor 106 that includes the quench zone 162 followed by the secondary zone 134. As shown in FIG. 15, the feed 120 including the nongaseous precursor, as discussed previously, is introduced into flame reactor 106 through burner 112 and into flame 114 in primary zone 116. Within primary zone 116 nanoparticulates nucleate and form in the flowing stream. The flowing stream is then quenched in the quench zone 162 and then the nanoparticulates are further grown in the secondary zone 134.

As one example referring to FIG. 15, the nanoparticulates that form in the flowing stream may have a crystal structure that is useful for a final application and it is desirable to retain the crystal structure, which is otherwise lost if kept at the temperature of the flowing stream as it exits primary zone 116. The feed 164 of quench gas introduced into quench zone 162 cools the nanoparticulates to a temperature that retains the desirable crystal structure. The secondary zone 134 downstream of the quench zone may then be used to further grow the nanoparticulates while retaining the desired crystal structure.

As another example with reference to FIG. 15, the nanoparticulates that nucleate and form in the flowing stream in primary zone 116 may be at a temperature at which they grow more quickly than desired. Quenching in the quench zone 162 temporarily stops or slows down the growth of the nanoparticulates. After the quench zone 162, the nanoparticulates flow into the secondary zone 134, where they may be controllably grown into a desired weight average particle size. Processing in the secondary zone may include, for example, addition of precursor to add additional material to the nanoparticulates, or addition of heat to raise the temperature of the flowing stream to controllably recommence or accelerate the rate of particle growth through collisions.

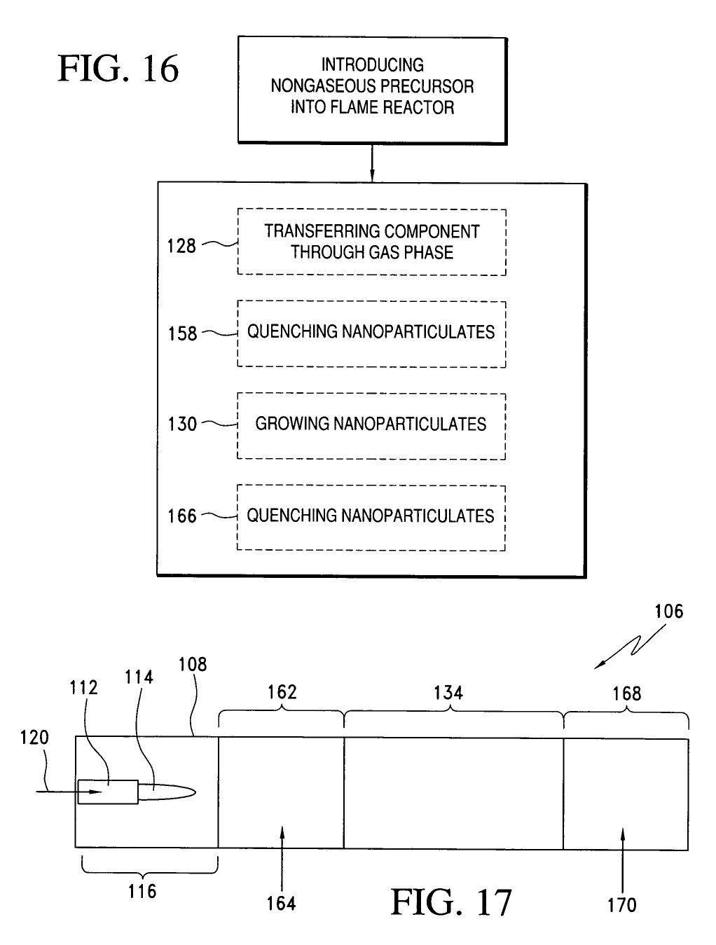

FIG. 16 shows a generalized process block diagram of another embodiment of the method of the present invention that includes a the quenching 158 as a first quench step, followed by the growing nanoparticulate step 130 and a quenching 166 as a second quench step. FIG. 17 shows one embodiment of the flame reactor 106 that may be used to implement the method that is shown in FIG. 16. The embodiment of flame reactor 106 shown in FIG. 17 includes the primary zone 116, the quench zone 162 as a first quench zone, the secondary zone 134, and a quench zone 168 as a second quench zone. The feed 164 of quench fluid is introduced into the first quench zone 162 and a feed 170 quench fluid is introduced into the second quench zone 168.

The method of the present invention shown in FIG. 16, and the flame reactor shown in FIG. 17 that may be used to implement the method shown in FIG. 16, may be useful for processing a variety of nanoparticulates. As shown in FIG. 16, the feed 120 is introduced into flame reactor 106 through burner 112 and into flame 114 in primary zone 116. Within primary zone 116 nanoparticulates nucleate and form in the flowing stream. The temperature of the flowing stream is then reduced in the quenching 162, further nanoparticulate growth occurs in secondary zone 134 and the temperature of the flowing stream is then lowered again in the quench zone 168. Processing in the quench zone 168 may, for example, prepare the nanoparticulates for further processing or for collection.

The previous descriptions with respect to FIGS. 14-17 are provided merely as illustrative examples of different embodiments that incorporate a quenching nanoparticulate step. The method of the present invention may include one or two quenching steps or more than two quenching steps. In some embodiments, a quenching step may follow and/or precede other processing steps or substeps that have been previously described or that are described below, or other steps not described herein the inclusion of which are not incompatible with other processing. Additionally, in those embodiments that include more than one quenching step, the quench fluid used in each of the steps may be the same or different.

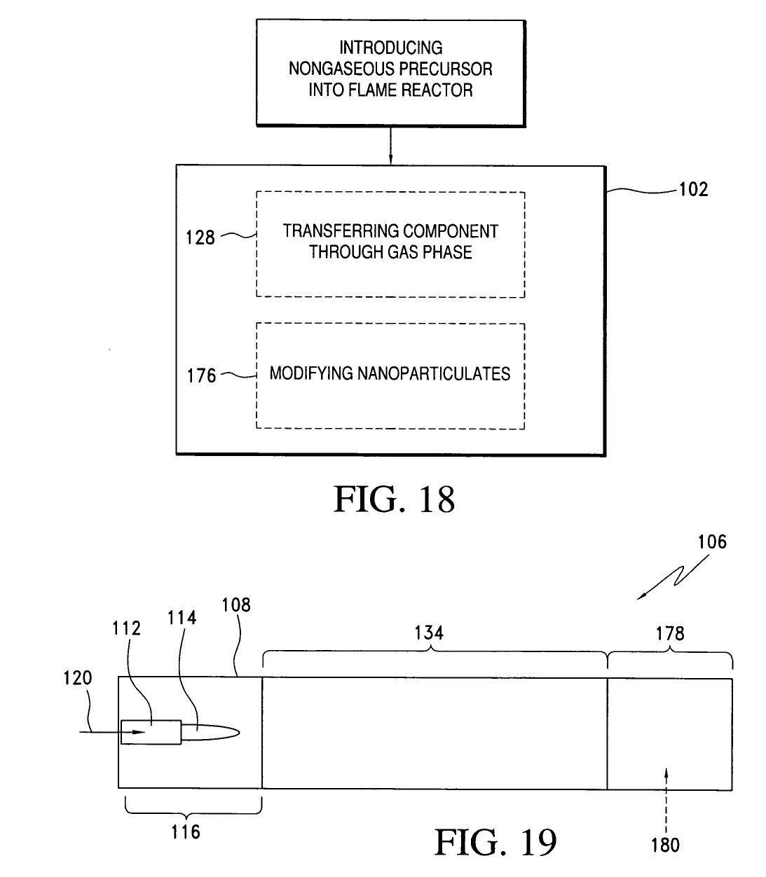

FIG. 18 shows a generalized process block diagram of another embodiment of the method of the present invention where the forming 102 includes modifying 176 nanoparticulates. The modifying nanoparticulates step 176 may be useful, for example, to change the properties of the nanoparticulates after they have formed and/or have been grown into a desired weight average particle size. By the term “modify” or “modifying,” it is meant a change to the nanoparticulates that does not necessary involve increasing the weight average particle size of the nanoparticulates. The modification may be morphological or chemical. By morphological it is meant changes to the structure of the nanoparticulates, with some nonlimiting examples including a redistribution of phases within the nanoparticulates, creation of new phases within the nanoparticulates, crystallization or recrystallization of the nanoparticulates and homogenization of the nanoparticulates. A chemical modification to the nanoparticulates includes compositional changes to the nanoparticulates such as adding an additional component or removing a component from the nanoparticulates to change the chemical composition of the nanoparticulates, preferably without substantially increasing their weight average particle size. For example, the nanoparticulates may be doped with a doping material to change the luminescent, conductive, magnetic or other materials properties of the nanoparticulates. In another example, a surface modifying material may be added to the surface of the nanoparticulates in order to aid the dispersion of the nanoparticulates for use in a final application.

FIG. 19 shows an embodiment of the flame reactor 106 that may be used to implement the method of the present invention shown in FIG. 18. The flame reactor 106, includes the primary zone 116, the secondary zone 134 and a modifying zone 178. The modifying zone 178 is used to perform the modifying nanoparticulates 176. Unless subjected to a prior quench, the flowing stream in the modifying zone 178 will still typically be at an elevated temperature because of the residual heat from upstream operations. However, the temperature will often preferably be significantly below those temperatures described above with respect to the secondary zone 134 during the growing 130, and a quench may be useful between the secondary zone 134 and the modifying zone 178 to adjust the temperature as desired. For example, the temperature of the nanoparticulates when processed through the modifying 176 will typically be significantly lower than a melting temperature of any of the materials in the nanoparticulates and preferably below the sintering temperature of the nanoparticulates, to avoid growth of the nanoparticulates through collisions. In any case, the nanoparticulates should be maintained at a temperature at which the desired modification of the nanoparticulates occurs.

The modifying zone 178 may be designed similarly with discussions above concerning design of the secondary zone 134. The descriptions of the various designs of the secondary zone 134 described above, with respect to FIGS. 7-10, are applicable to the modifying zone 178. For example, the modifying zone 178 may include an insulator around the portion of conduit 108 that forms the modifying zone 178, as shown in FIG. 7. The insulator may be useful to retain heat in the flowing stream while the flowing stream is in modifying zone 178. Additionally, the modifying nanoparticulates 176 may include the addition of heat, in which case heat will be added to modifying zone 178. FIGS. 8-10 described above, with respect to secondary zone 134, are applicable to adding additional heat to modifying zone 178. For example, additional heat may be added using a heater as described with respect to FIG. 8 or by flames such as described with respect to FIGS. 9 and 10 above.

FIG. 19 also shows optional feed 180 of modifying material that may be introduced into the modifying zone 178 when the modifying 176 includes a chemical, or compositional, modification. The feed 180 of modifying material may be introduced into the modifying zone 178 in a variety of ways, including, all of the ways previously described with respect to the feed 154 of FIG. 11. For example, the modifying feed 180 may be introduced through a burner and into a flame in modifying zone 178.

Feed 180 of modifying material may include multiple phases such as a gas phase and a nongaseous phase. The nongaseous phase may include a liquid, a solid or a combination of a liquid and a solid. The modifying feed 180 includes a modifying material, or a precursor to a modifying material, which modifies the nanoparticulates while in the modifying zone 178. The term “modifying material” is meant to include any material that is involved in “modifying” the nanoparticulates as the term has been previously defined. The modifying feed 180 may include a gaseous or nongaseous precursor to a modifying material. The precursor to the modifying material may be in a liquid phase of the feed 180, a solid phase of feed 180, in a gaseous phase of feed 180 or a combination of the foregoing.

In addition to precursors, feed 180 may also include other components. For example, feed 180 may include gases that do not have any function in the modifying nanoparticulates 176, but merely be used to carry nongaseous components, such as a precursor, into the modifying zone 178. The modifying feed 180 may also include nongaseous components that are not precursors. As one example, feed 180 may include droplets of water, which are introduced into modifying zone 178 to absorb heat from the flowing stream and control the temperature within modifying zone 178. The foregoing are merely examples of the composition of feed 180 and are not intended to be limiting. In other embodiments, feed 180 may include components that have not been mentioned above, or include any combination of the components that have been mentioned above.

In one specific example of adding a modifying material in feed 180, a material may be introduced in feed 180 that prevents the nanoparticulates from growing. The modifying material may be an organic material or an inorganic material that deposits on the surface of the nanopaticulates and prevents them from growing by modifying the surface of the nanoparticulates so that when they collide they do not stick together and join. Some nonlimiting examples of ways in which the modifying material may prevent the nanoparticulates from sticking together when colliding include, by depositing a hard material on the nanoparticulates so that they are more likely to bounce off of each other than to stick together and by depositing an ionic material that will repel nanoparticulates away from each other. It should be noted that the modifying material might increase the weight average particle size of the nanoparticulates, because additional material is being added to their surface, but preferably does not significantly increase their size, or if the size is appreciatively increased the weight average particle still remains within a desired range. Moreover, the modifying material may, in addition to being useful to prevent the nanoparticulates from growing, be useful in a final application of the nanoparticulates. However, in other cases, the modifying material may only be used to prevent the nanoparticulates from growing while in flame reactor 106 or agglomerating during or following collection and may be removed before the nanoparticulates are used in a final application. The additional material may be removed from the nanoparticulates in a variety of ways, such as for example dissolved by a solvent, vaporized, reacted away, or a combination of the foregoing, preferably with minimal effect on the properties of the nanopaticulates.

A compositional modification in the modifying zone 178, may include any modification of the composition of the nanoparticulates. One such modification is to coat the particles with a coating material. Such coating may be accomplished in the particle modifying for example, by physical vapor deposition (PVD), chemical vapor deposition (CVD), gas-to-particle conversion, or conversion of a material of the nanoparticulates at the particle surface.

It should also be noted that the method of the present invention is not limited to the embodiments described herein where feed 180 is used to introduce a modifying material into the flame reactor. In some instances a modifying material may already be present in the flowing stream when the flowing stream enters the modifying zone 178, such as for example by virtue of having been included in the flowing stream during the introducing 100, or by having been introduced into the flame reactor upstream from the modifying zone 178. In those cases, the modifying material may have the same purpose and functions as previously described above with respect to introducing the modifying material in feed 180. In other cases modifying materials may be introduced at other various locations in the flame reactor 106.

The residence times of the nanoparticulates within the modifying zone 178 will vary depending on the desired modification of the nanoparticulates. Typical residence times of the nanoparticulates within the modifying zone 178 may be similar to the residence times within the secondary zone 134, discussed above.

In one specific embodiment of the present invention, the volume concentration of nanoparticulates in the flowing stream will be controlled so that it is at or below the characteristic volume concentration when in the modifying zone 178 to inhibit further particle growth. Additionally, with such a low volume concentration of the nanoparticulates, the modifying 176 may be performed at higher temperatures than if the volume concentration were above the characteristic volume concentration.

The flame reactor that is shown in FIG. 19 and the various embodiments discussed above with respect to FIG. 18 are only for illustrative purposes. In other embodiments, the flame reactor may include more than one modifying zone, and the method will include more than one modifying nanoparticulates step. Additionally, the modifying nanoparticulates steps may be combined in any order with other steps or substeps that have previously been described or that are described below.

The ability to combine steps and substeps discussed above provides advantages in processing nanoparticulates with complex materials (i.e., materials with more than two elements). Some examples of complex materials include mixed metal oxides such as phosphors and glasses. One problem with processing nanoparticulates that inlcude complex materials is that oftentimes the component materials in the complex materials have very different properties such as vaporization temperatures (i.e., boiling points) that make formation of the nanoparticulates in a single processing step difficult. For example, a first component of the complex material may have a very high vaporization temperature, while a second component a very low vaporization temperature. If processed in a single step, both components will be in a single gas phase while in a primary zone. As the temperature of the gas phase drops, the first component will nucleate and form nanoparticulates, then as the temperature falls further, the second component will deposit on the first component and/or nucleate and form separate nanoparticulates. Thus, the resulting nucleated nanoparticulates will be nanoparticulates with two phases (i.e., core/shell) and/or two separate nanoparticulates of distinct compositions.

In several embodiments of the present invention, a combination of substeps that include combinations of the growing 130, quenching 158 and modifying 176 may be used in various combinations to process nanoparticulates that include complex materials. One example includes introducing a first component, having a high-vaporization temperature, and a second component having a low-vaporization temperature into a primary zone of a flame reactor. As the nanoparticulates begin to nucleate and form, they may be subjected to a quenching nanoparticulates step that reduces the temperature of the nanoparticulates to a temperature below the vaporization temperature of the second component in the form it exists in the vapor phase, causing the second component to come out of the vapor phase for inclusion in the nanoparticulates, promoting inclusion of both the first component and the second component in the nanoparticulates. Additionally, the quenching nanoparticulates may be followed by a modifying nanoparticulates where the nanoparticulates are maintained at a temperature that will homogenize them to evenly distribute the first and second components throughout the nanoparticulates.

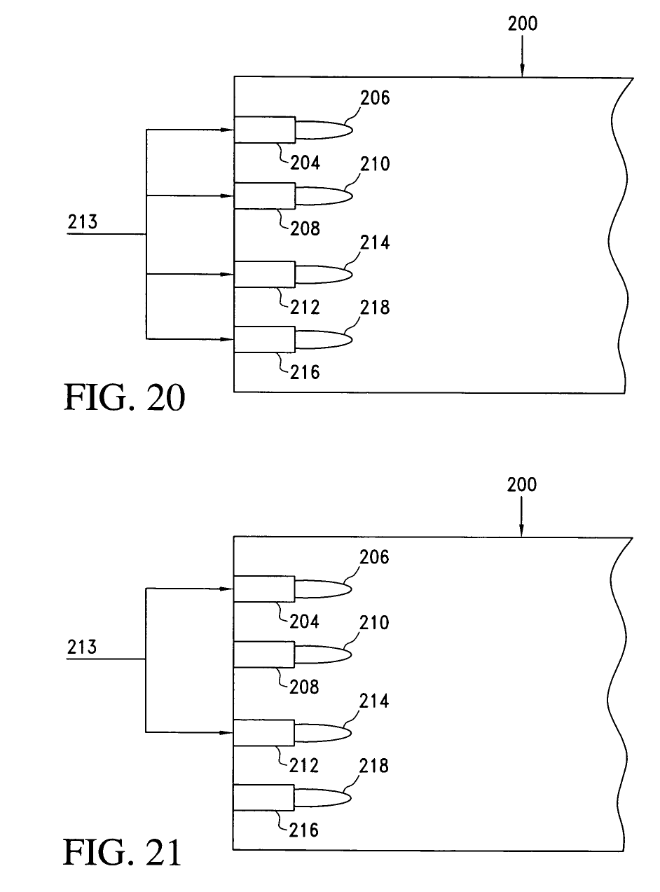

As previously stated, the method of the present invention may utilize any flame reactor that is suitable for forming the desired nanoparticulates. FIG. 20 shows one embodiment of a flame reactor that includes a plurality of burners and flames. The specific embodiment of the flame reactor 200 shown in FIG. 20 has four burners, 204, 208, 212, and 216, which generate four flames 206, 210, 214 and 218. Flame reactor 200 may be used to implement any of the embodiments of the method of the present invention that has been described above or described herein, but is particularly useful for those embodiments in which the introducing the nongaseous precursor involves introducing the nongaseous precursor through a burner and into a flame. Use of the flame reactor 200 may provide several advantages over flame reactors that use only a single burner and a single flame, when high throughput volumes are desired. One advantage is the ability to produce larger amounts of nanoparticulates. Because more than one burner is being used to generate nanoparticulates, the production rate of flame reactor 200 is much greater than if only a single burner and a single flame of the same type were being used instead. In some embodiments a flame reactor, similar to flame reactor 200, that uses a plurality of burners and a plurality of flames is used to generate nanoparticulates at a production rate that exceeds 1 kilogram per hour and may be as high as several hundred kilograms per hour. y

An additional advantage of using flame reactor 200 is the ability to closely control the properties of each individual flame and consequently the properties of the nanoparticulates, while still maintaining a high production rate. When scaling up a flame reactor from a small scale pilot reactor or experimental reactor to a large scale production reactor many engineering problems may be encountered, such as for example, maintaining the stability, temperature and temperature profile of a large flame with large volumes of gas flowing through the burner used to generate the flame. With the flame reactor design shown in FIG. 20, the engineering difficulties of scaling up to a large production rate may be reduced. For example, the problems associated with maintaining a large flame, or flowing large volumes of gas into a single burner, are avoided by the use of multiple burners.

With continued reference to FIG. 20, in addition to the burners (204, 208, 212 and 216) and flames (206, 210, 214 and 218), FIG. 20 shows a feed 213 that includes a nongaseous precursor being fed through burners 204, 208, 212 and 216 and into flames 206, 210, 214 and 218 respectively. The feed 213 is a flowing stream that includes the nongaseous precursor that has a component for inclusion into the nanoparticulates as described above. After feed 213 is introduced into flames 206, 210, 214 and 218, the nanoparticulates will typically nucleate and form within or in the immediate vicinity of each of flames 206, 210, 214 and 218. Consequently, four flowing groups of nucleated nanoparticulates are initially formed in flame reactor 200. The four groups will then tend to mix as they move downstream in a single flowing stream in the common conduit.

FIG. 21 shows another embodiment of flame reactor 200. In the embodiment shown in FIG. 21, parts that are the same as those in FIG. 20 are numbered the same. As can be seen in FIG. 21, the feed 213 of flowing stream is introduced through only two of the burners, namely burners 204 and 212 and into only two of the flames 206 and 214. Therefore, in this embodiment nanoparticulates are being formed only in flames 206 and 214. In this embodiment, although flames 210 and 218 are not generating nanoparticulates they are being used to provide additional heat into flame reactor 200. The additional heat provided by flames 210 and 218 may aid in any number of processes including: formation of the nanoparticulates within flames 206 and 214, a downstream step such as a growing the nanoparticulatesor a modifying the nanoparticulates or combinations of steps.

Flame reactor 200 shown in FIG. 21 may be useful, for example, in situations where the nongaseous precursor being introduced into flame reactor 200 is incompatible with an oxidant or a fuel that is preferred or necessity for use in the processing. For example, in some cases a very high temperature is necessary within flame reactor 200 for making nanoparticulates, however the fuels that can generate the required temperatures may be incompatible with the nongaseous precursor. Flame reactor 200 shown in FIG. 21 allows the nongaseous precursor to be introduced into burners 204 and 212 with a first fuel that, although not providing enough heat, is compatible with the nongaseous precursor. A second fuel producing a higher level of heat may then be delivered through burners 208 and 216 to generate flames 210 and 218 and introduce into flame reactor 200, to provide the desired level of heat for processing.

It should be noted that flame reactor 200 shown in FIG. 21 is distinct from a flame reactor in which small pilot lights are used as an ignition source to generate a primary and usually central flame. Flames 210 and 218 in flame reactor 200 are intended to contribute a substantial amount of heat into flame reactor 200, the additional heat being used to in the processing of the nanoparticulates.

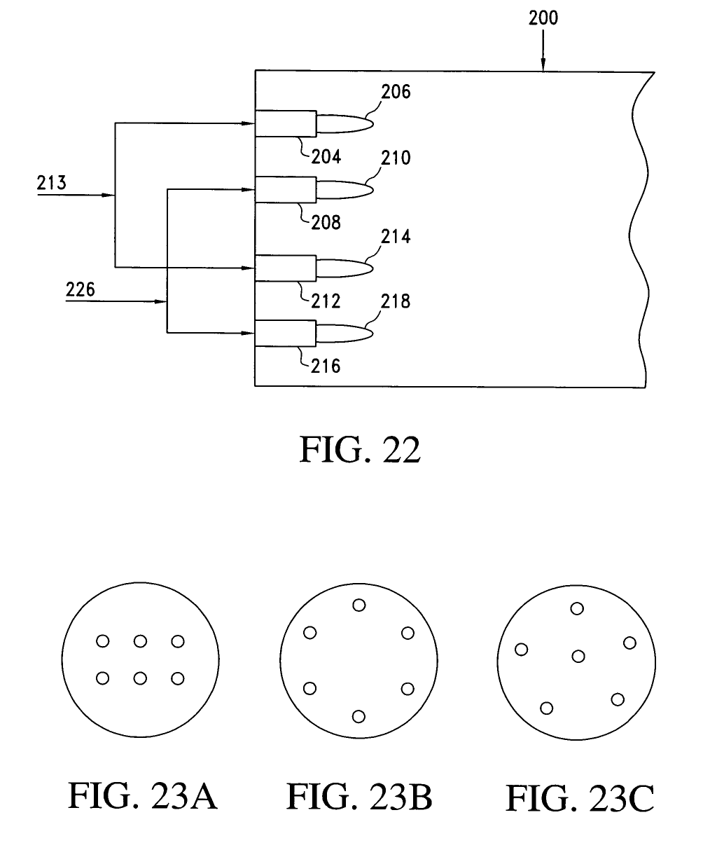

FIG. 22 shows another embodiment of flame reactor 200. In addition to the previously described parts, flame reactor 200 includes feed 213 of a first flowing stream and feed 226 of a second flowing stream. Both feeds 213 and 226 include a nongaseous precursor with a component for inclusion in nanoparticulates, however each feed is intended to form a different material for the nanoparticulates. As shown in FIG. 22, feed 213 is introduced through burners 204 and 212 and into flames 206 and 214 respectively. Feed 226 is introduced through burners 208 and 216 and into flames 210 and 218. Nanoparticulates of a first composition including a first material will nucleate and form within flames 206 and 214. Nanoparticulates of a second composition including a different second material will nucleate and form in flames 210 and 218. The different nanoparticulates may then collide and grow forming multi-phase nanoparticulates with both the first material and the second material. Alternatively, the particles may be processed in a way to inhibit such particle growth leading to the multi-phase particles, and the nanoparticulates may be collected as a mixture of the nanoparticulates of two different compositions. In this latter scenario, dividers may be placed between the different flames 206, 210, 214, 218 to maintain the different nanoparticulates separate until they have been sufficiently cooled so that they will not have a tendency to agglomerate upon collision. For example, the different groups of nanoparticulates could be maintained separate until mixed in a common conduit portion where a quench cooling takes place, to both reduce the temperature of the nanoparticulates and to promote intimate mixing of the nanoparticulates due to turbulence from the quench fluid.

The previously described process for using flame reactor 200 to generate intimately mixed nanoparticulates is a very useful process. There are many applications where it may be advantageous to have an intimate mixture of nanopariculates of different compositions. Nanoparticulates, however, because of their small size have very large specific surface areas and are difficult to disperse and intimately mix together with separate nanoparticulates of a different composition. Thus, the embodiment of the present invention described above allows an intimately mixed combination of nanoparticulates of different compositions to be collected from flame reactor 200, and avoids the complexity of having to try to mix separately manufactured nanoparticulates.

It should be noted that the description above with respect to FIG. 22 is intended to be non-limiting. In other embodiments, more than two feeds may be introduced into flame reactor 100. For example, four different feeds may be introduced through burners 204, 208, 212 and 216 and into flames 206, 210, 214 and 218, each burner and corresponding flame receiving a different feed and resulting in different nanoparticulate compositions. During processing, nanoparticulates of four different compositions will nucleate and form in flames 206, 210, 214 and 218 and mix within flame reactor 200 to form a stream of intimately mixed nanoparticulates of four different compositions or composite nanoparticulates with at least four different materials. In other embodiments, there may be more than four burners and flames, each forming a different composition of nanoparticulates. Additionally, it should be understood that each burner and flame is not limited to receiving only a single precursor or a single feed. Each burner and flame may receive more than one precursor in any form, such as a liquid, solid, gas or a combination thereof and may receive more than one feed.

In yet another implementation, the flame reactor 200 shown in FIG. 22 is used to produce nanoparticulates of a single composition, which may be multi-phase or single-phase nanoparticulates. In this embodiment, feed 213 contains a first precursor including a first component to be included in the nanoparticulates. Feed 226 contains a second precursor including a second component to be included in the nanoparticulates. Preferably, at least one of, and more preferable both of, the first precursor and the second precursor is nongaseous as fed to the respective burner. In this embodiment, the precursors are selected so that the nanoparticulates do not nucleate within the individual flames 206, 210, 214 or 218. Rather, the flames 206, 210, 214 or 218 are used to drive components of all nongaseous materials into the gas phase. Thus, flames 206 and flame 214 will produce a first gas of one composition that includes the first component, and flames 210 and 218 will form a second gas of a second composition that includes the second component. The two gases will then mix in flame reactor 200 and after the mixing the nanoparticulates will nucleate at a lower temperature downstream of the flames, and the nanoparticulates would include both the first component and the second component, either in the same or a different phase.

This embodiment may have significant advantages in some situations. One advantage may be an ability to create nanoparticulates using precursors that would be incompatible if fed together. In this situation, it may be difficult to generate a single feed stream that includes both precursors and both components. Thus, with the flame reactor shown in FIG. 22, nanoparticulates may be made that include both the first component and the second component without the need to generate a single flowing stream with both precursors. It should also be noted, in other embodiments of the flame reactor shown in FIG. 22 there may be more than four burners and flames with each burner and flame receiving a single feed or more than one feed. Additionally, each feed may contain a single precursor or multiple precursors.

The previous description of flame reactors that include a plurality of burners that generate a plurality of flames such as those described with respect to FIG. 20-22 may have the plurality of burners and flames arranged in any suitable way in the flame reactor. Some examples of how the burners may be arranged are shown in FIGS. 23A-23C, the view is from a downstream position looking upstream through the conduit at the burners. FIG. 23A shows an embodiment in which there are six burners that are arranged in a row and column fashion. FIG. 23B shows six burners that are arranged in the form of a circular pattern. FIG. 23C shows six burners, with five burners being arranged in a circular pattern and a single burner being arranged in the middle of the circular pattern. It should be noted that the arrangements shown in FIGS. 23A-23C are merely illustrative. In other embodiments, their may be more than six burners or less than six burners arranged in different patterns, such as for example, with respect to FIG. 23A, the burners may be arranged so that the burners in the bottom row are not immediately underneath the burners in the top row but rather are staggered. As another example, the burners may be arranged in a single straight line.

Although a flame reactor for use with the method of the present invention may include any burner that is suitable for heating a flame reactor, multi-channel burners are preferred for many implementations of the method of the present invention. By the term “multi-channel burner” it is meant a burner with at least two channels or flow paths where different feeds that may include a nongaseous precursor, an oxidant, a fuel and other materials are introduced into the burner. As a nonlimiting example, multi-channel burners allow an oxidant, a fuel and a precursor material to all be segregated and fed into different channels of a burner. As another nonlimiting example, every channel of a multi-channel burner may receive the same feed, which may be a combination of fuel, oxidant and/or precursor. Multi-channel burners have several advantages over a single channel burner based on the ability to feed different combinations of materials into separate channels. One major advantage is the ability to control the characteristics (e.g., shape, temperature and temperature profile) of the flame by changing the composition of feeds and the channels into which the feeds are introduced. Control over the characteristics of the flame also allows the properties of nanoparticulates formed within the flame to be controlled. For example, controlling the temperature of the flame may allow control over the crystallinity of materials included in the nanoparticulates. Additionally, a uniform temperature profile throughout a flame will generate particles with uniform properties regardless of whether formed at the center of the flame or whether formed near an edge of the flame.

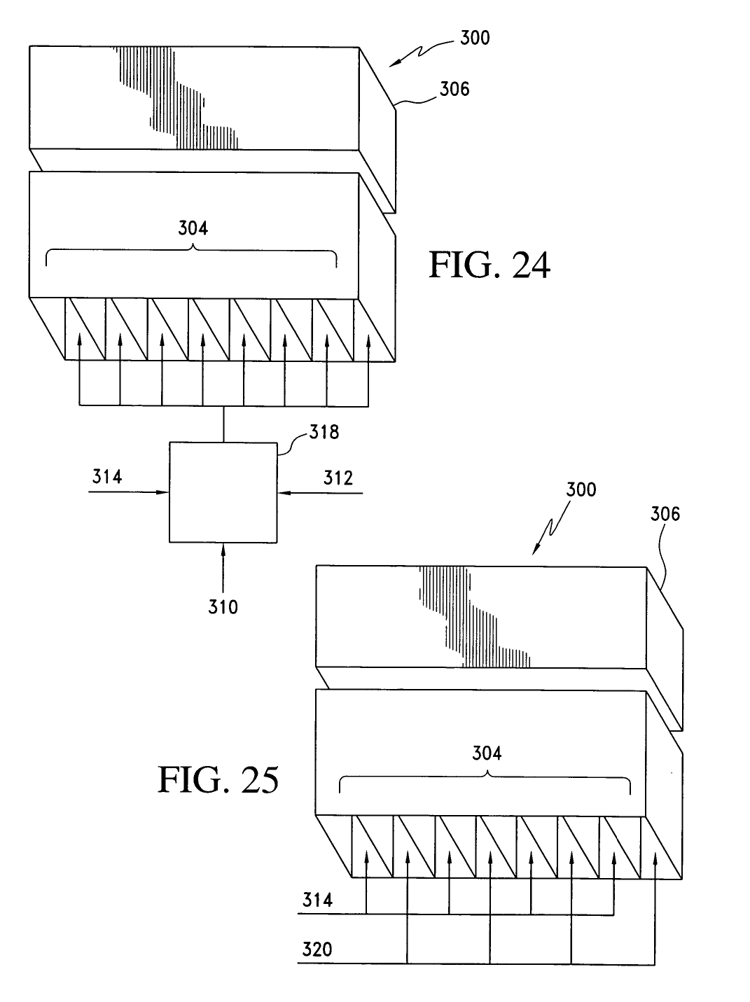

FIG. 24 shows an embodiment of a multi-channel burner 300 that may be used in performing the method of the present invention. Multi-channel burner 300 is a slot burner that includes a plurality of slot channels 304. In the embodiment shown in FIG. 24, burner 300 is used to generate a flame sheet 306. One advantage evident from the shape of flame sheet 306 is the large flame area available for reacting precursors, vaporizing precursors and/or forming nanoparticulates. Also, as a result of its uniform dimensions, flame sheet 306 has a relatively uniform temperature profile. The uniform temperature profile allows nanoparticulates formed in flame sheet 306 to have uniform properties regardless of whether they are nucleated and formed near the edges of flame sheet 306 or in the center of flame sheet 306 since both area will have similar temperatures.

Also shown in FIG. 24 are feeds 310 containing a nongaseous precursor, 312 containing a fuel and 314 containing an oxidant. Feeds 310, 312 and 314 are premixed prior to introduction into the plurality of slot channels 304. As shown in FIG. 24, feeds 310, 312 and 314 are introduced into a mixing chamber 318 where they are premixed prior to introduction into the plurality of slot channels 304. Once feeds 310, 312 and 314 have been premixed in mixing chamber 318, they are distributed, such as by a manifold system, into the plurality of slot channels 304. The oxidant and the fuel will combust to form flame sheet 306.

The mixing chamber 318 may be any type of chamber or container useful for mixing gases. In one specific embodiment, mixing chamber 318 is a plenum that is located underneath the plurality of slot channels 304; feeds 310, 312 and 314 all being introduced into the plenum which is in fluid communication with the plurality of slot channels 304. In this embodiment, there is no need to have an additional manifold system that delivers the premixed feed into the plurality of slot channels 304. In other embodiments, the mixing chamber 318 may recieve less than the three previously described feeds. For example, any of feeds may be combined or mixed prior to feeding into mixing chamber 318, or be generated including any combination of fuel, oxidant and precursor.

In another embodiment of the method of the present invention, each burner of a multi-channel burner may receive a feed with a different composition. FIG. 25 shows one embodiment of slot burner 300 in which two different feeds are being fed into the plurality of slot channels 304. A feed 314 containing an oxidant is introduced into half of the plurality of slot channels 304. A feed 320 containing a combination of a fuel and a nongaseous precursor is introduced into the other half of the plurality of slot channels 304. Above the slot burner 300, the oxidant and fuel will mix and combust to form flame sheet 306.

Feed 320 that contains both a precursor and a fuel may be formed in a variety of ways. In one particular embodiment, the nongaseous precursor is dissolved in a liquid, and the liquid is dispersed in a gas phase, the gas phase including a gaseous fuel. In another embodiment, the nongaseous precursor may be dissolved in a liquid, the liquid also being the fuel combusted to generate flame sheet 306. In yet another embodiment, the nongaseous precursor may be dissolved in a liquid, liquid also being a fuel combusted to generate flame sheet 306. The liquid with the nongaseous precursor may then be dispersed in a gas phase, which also includes a gaseous fuel, which is combusted with the oxidant to form flame sheet 306. Any combination of solid, liquid and gaseous fuel and precursor may be used in feed 320. Feed 314 may include a gaseous oxidant, a nongaseous oxidant or a combination of the two. The composition of the oxidant may be any of the previously described oxidants or any combinations thereof. Feed 314 may also include other materials that are not oxidants and are not combusted to form flame sheet 306. For example, feed 314 may include air, which includes nitrogen, argon, carbon dioxide and other trace gases. In another example, feed 314 may include a dispersed nongaseous phase such as water that is used to control the temperature of flame sheet 306.

The delivery of different feeds into different channels of the plurality of slot channels 304 may be accomplished using two manifold systems that distribute the feeds into the plurality of slot channels 304. For example, in FIG. 25 a manifold system may be used to deliver feed 314 into half of the plurality of slot channels 304, and a second manifold system may be used to deliver feed 320 to the other half of the plurality of slot channels 304.

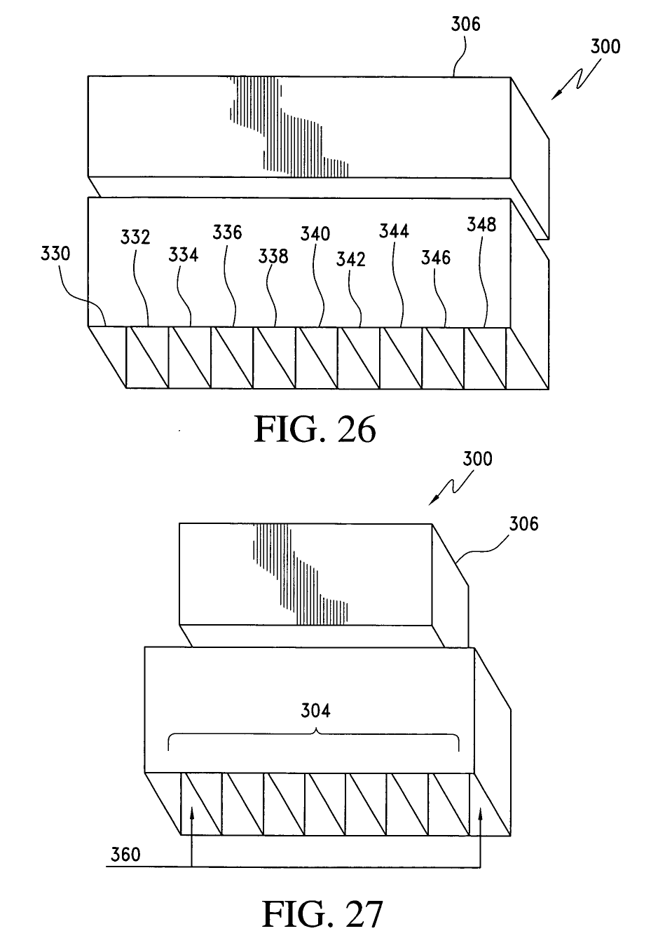

With reference now to FIG. 26, FIG. 26 shows burner 300 with a plurality of burners 304 individually numbered in order to describe a variety of combinations of different segregated feeds introduced into the plurality of slot channels 304. For example in one embodiment, channel 334 may receive a feed including nongaseous precursor, with channels 332 and 336 receiving a feed with a fuel, while channels 330 and 338 receive a feed with an oxidant. A similar pattern may then be followed with the remaining channels (i.e., channel 344 receives a feed with a precursor, channels 342 and 346 receive a feed with a fuel and channels 340 and 348 receive a feed with an oxidant). In another embodiment, channel 334 may receive a feed with a combination of fuel and nongaseous precursor, with channels 332 and 336 receiving a feed with an oxidant and channels 330 and 338 receiving additional fuel, with this pattern being followed with the remaining channels. In yet another embodiment, channel 334 may receive a feed with a combination of an oxidant and nongaseous precursor, with channels 332 and 336 receiving a feed with a fuel and channels 330 and 338 receiving additional oxidant, with this pattern being followed with the remaining channels. The pattern of having a central channel receiving one type of feed and two channels on either side of the central channel receiving other types of feeds may be used in a variety of embodiments and is useful in controlling the characteristics of a flame and ultimately the properties of nanoparticulates formed within a flame. Thus, the embodiments detailed above are intended to be non-limiting. In other embodiments, the different feeds may be introduced in an alternating pattern of two or more feeds. For example, channel 330 may receive an oxidant, with channel 332 receiving a fuel, and channel 334 receiving a combination of fuel and nongaseous precursor combination. The pattern is then repeated with channel 336 receiving an oxidant, channel 338 receiving a fuel and channel 340 receiving a combination of fuel and nongaseous precursor. The foregoing examples are intended to be non-limiting examples.

In addition to the various combination of feeds previously described with respect to FIGS. 24-26, feeds may include other materials that have not been previously described. FIG. 27 includes the addition of a feed 360 which includes a barrier gas. The addition of a barrier gas in feed 360 may have a variety of purposes. For example, in FIG. 27, the feed 360 is introduced into the two outermost slot channels of the plurality of channels 304. In this embodiment, the feed 360 is useful in creating a barrier between flame 306 and the surrounding environment. The barrier may serve a several purposes, for example, preventing additional oxygen from the surrounding air from being entrained into flame sheet 306, causing the characteristics of flame sheet 306 to change. In other cases, the surrounding environment may contain contaminants that would otherwise be included in nanoparticulates being nucleated and formed within flame sheet 306 were it not for the barrier.

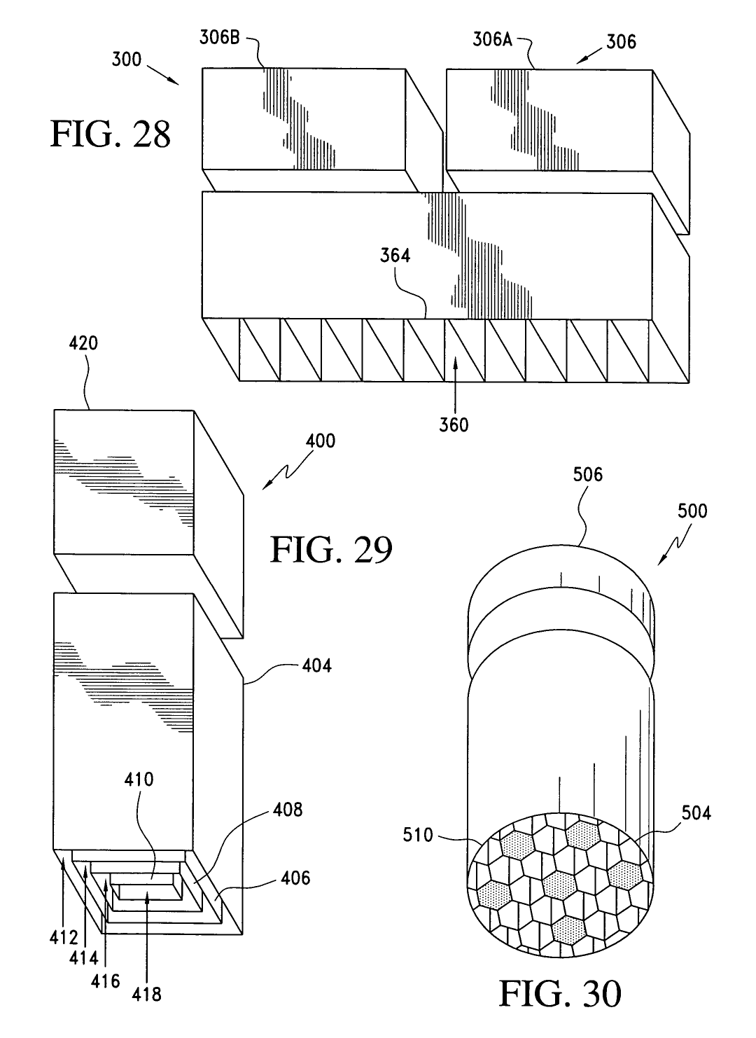

In other embodiments, barrier gas may be introduced in a middle channel of the plurality of slot channels 304. For example, FIG. 28 shows one embodiment of slot burner 300 which includes the addition of feed 360 containing a barrier gas into a middle channel of the plurality of slot channels 304. In the embodiment shown in FIG. 28, the addition of feed 360 divides flame sheet 306 into two separate flame sheets, sheet 306A and sheet 306B. The remaining plurality of slot channels 304 receive a feed with any combination of a nongaseous precursor, an oxidant and a fuel, such as feeds previously described with respect to FIGS. 24-26.

In one embodiment of FIG. 28, nanoparticulates of two different compositions may be formed. Nanoparticulates of a first composition may be formed in flame sheet 306A and nanoparticulates of a second composition may be formed in flame sheet 306B. In this embodiment, at least one of the plurality of channels 304 that are to the left of slot 364, which receives feed 360 of barrier gas, receives a first precursor and at least one of the plurality of channels 304 that are to the right of slot channel 364 may receive a second precursor. Additionally, oxidant and fuel are fed into some of the plurality of channels 304 on either side of slot channel 364 to combust and form the flame sheets 306A and 306B. After the nanoparticulates have formed in flame sheets 306A and 306B they will mix to form an intimately mixed combination of nanoparticulates of different compositions. This embodiment advantageously allows the production of one stream containing nanoparticulates of two different compositions.

It should be understood that the foregoing description of FIG. 28 is intended to be non-limiting. In other embodiments, burner 300 may have more than the number of slots shown in FIG. 28 and more than just one slot channel receiving a barrier gas. Consequently, burner 300 may form more than two flame sheets. For example, there may be three flame sheets, four flame sheets, or even more than four flame sheets. Also, in some embodiments nanoparticulates of different composition may form in each flame sheet creating a stream with a combination of nanoparticulates of more than two compositions, such as for example, three compositions, four compositions, or more than four compositions.

In other embodiments of slot burner 300 shown in FIG. 28, feed 360 containing a barrier gas may be introduced into slot channel 364 merely to control the temperature of flame sheet 306. In this embodiment, feed 360 may be introduced at a low velocity or may contain a small volume of barrier gas so that flame sheet 306 is not separated into flame sheets 306A and 306B. The barrier gas in feed 360 is intended to mix with the oxidant and fuel to dilute the oxidant and fuel making less available for combustion, which reduces the temperature of flame sheet 306. This may be advantageous when the nanoparticulates being formed in flame sheet 306 require a lower temperature than would normally be achieved by combusting an oxidant and a fuel to form flame sheet 306. In other embodiments, more than one of the plurality of channels may receive feed 360.

The slot burners and the feeds introduced into the slot burners described in FIGS. 24-28 are merely exemplary and are nonlimiting. Slot burners that may be used with the present invention may include more slot channels than those shown in FIGS. 24-28 or may include less slot channels than those shown in FIGS. 24-28. Also, the feeds and the combination of feeds previously described with respect to FIGS. 24-28 are also intended to be nonlimiting (i.e., a feed may have any combination of fuel, oxidant, nongaseous precursor, barrier gas or other material not described above). In some cases, the pattern of introducing feeds into a plurality of channels may be different than those described above or may be a combination of those described above. Additionally, the number of different feeds introduced into a slot burner may be more than those described above, such as for example, four feeds, five feeds, six feeds or even more than six different feeds.

FIG. 29 shows one embodiment of a square burner 400. Square burner 400 is another example of a multi-channel burner that may be used with the method of the present invention. Square burner 400 is made from four coaxial rectangular conduits, outer conduits 404, middle conduits 406 and 408, and inner conduit 410. The four coaxial rectangular conduits provide four channels, channel 412, channel 414, channel 416, and channel 418 for introduction of different feeds into burner 400. In implementing the method of the present invention, a precursor, an oxidant and a fuel are delivered into burner 400. The oxidant and the fuel are combusted to form flame 420. In those embodiments in which the nanoparticulates are formed within flame 420, flame 420 provides the advantage of having a uniform shape (i.e. an elongated rectangular solid shape), which translates into a uniform temperature profile within flame 420. As previously described with respect to slot burners, the uniform shape of a flame provides uniform temperatures within the flame and translates to more uniform properties for nanoparticulates forming and nucleating within the flame.

The previous discussion regarding the advantages of multi-channel burners, with respect to FIGS. 24-28 are also applicable to square burner 400. Additionally, the discussion of different feeds into the plurality of slot channels also discussed above with respect to FIGS. 24-28 is also applicable to square burner 400. For example, channels 412, 414, 416 and 418 may all receive a feed containing the same composition, which includes a combination of fuel, oxidant, nongaseous precursor and barrier gas. As another example, channels 412, 414, 416 and 418 may all receive a feed containing a different composition, which may include fuel, oxidant, nongaseous precursor, barrier gas and combinations thereof. In one specific implementation of this example, a mixture of precursor and fuel may be fed into channel 418, while a barrier gas is fed into channel 416, an oxidant is fed into channel 414 and another feed of barrier gas is fed into channel 412. It should be noted, that any combination of precursor, barrier gas, oxidant and fuel may be introduced into any one of channels 412, 414, 416 and 418. Also, square burner 400 shown in FIG. 29 is merely one embodiment. In other embodiments, square burner 400 may include more than four concentric rectangular conduits, which form more than four channels, or may include less than four concentric rectangular conduits, which will form less than four channels.

FIG. 30 shows another embodiment of a multi-channel burner that may be used with a method of the present invention. FIG. 30 shows an embodiment of a honeycomb burner 500, which includes a plurality of channels 504 that have a hexagonal cross section. Honeycomb burner 500 generates a flame 506 that has a uniform shape (cylindrical) and large area that provides the same advantage as flame sheet 306 discussed above with respect to FIGS. 24-28. Similar to the previously described multi-channel burners (slot burner and square burner), the feeds into the plurality of burners 504 may include a precursor, an oxidant, a fuel, a barrier gas and combinations of the foregoing. The feeds into plurality of channels 504 may have the same composition or each channel may receive a nongaseous precursor, an oxidant, a fuel, a barrier gas and combinations of the foregoing. In one specific embodiment, a center channel is fed a combination of precursor and fuel, and the six channels surrounding the central channel receive an oxidant. Fore example, referring to FIG. 30, the channels that are shaded in gray would receive a feed of combined precursor and fuel, while the remaining channels that are not shaded in gray receive an oxidant. In another embodiment, the channels that are shaded in gray may receive a combination of precursor and oxidant, and the channels not shaded in gray receive a fuel. These are merely some examples of combinations of feeds that may be introduced into the plurality of channels 504. In other embodiments, the pattern of feeds into the plurality of channels 504 may be something other than a center channel receiving one feed surrounded by six channels receiving a different feed. As another nonlimiting example, in each row of channels, each channel may alternately receive a feed including an oxidant and another feed including a combination of fuel and nongaseous precursor, with the same pattern repeating in subsequent rows. In yet another nonlimiting example, the feeds introduced into the plurality of channels may be introduced somewhat randomly without any particular pattern, although this is less preferred.

In one specific embodiment, all of the plurality of channels that are adjacent to the outer edge 510 receive a barrier gas. This embodiment may be useful to separate, or create a barrier, between the flame generated from burner 500 and the surrounding environment. As previously describe, this may be useful to avoid contamination of nanoparticulates that are being formed within flame 506 and to avoid introducing additional oxygen from the surrounding environment into flame 506, which may change the characteristics of flame 506.

Another aspect of flame reactors used with the method of the present invention are features that prevent or reduce thermophoretic losses especially in secondary zones, quench zones and modifying zones. As previously described, in some methods of the present invention, nanoparticulates will have relatively long residence times in secondary zones, quench zones and modifying zones. One potential problem that may occur in situations where nanoparticulates have long residence times within a zone is thermophoretic loss. By the term “thermophoretic loss” it is meant the loss of nanoparticulates by deposition of the nanoparticulates onto the walls of the conduit. The thermophoretic losses are caused by differences in temperature between the hot material in the flowing stream and the cooler walls of a zone. This difference in temperature creates a force that draws the hot material in the flowing stream, including the nanoparticulates to the walls of a zone where they will deposit onto the walls. Thermophoretic losses result in an inefficient process that produces less nanoparticulate yield per amount of precursor. Thus, flame reactors that are used with the method of the present invention preferably include features that help to limit or avoid thermophoretic losses.

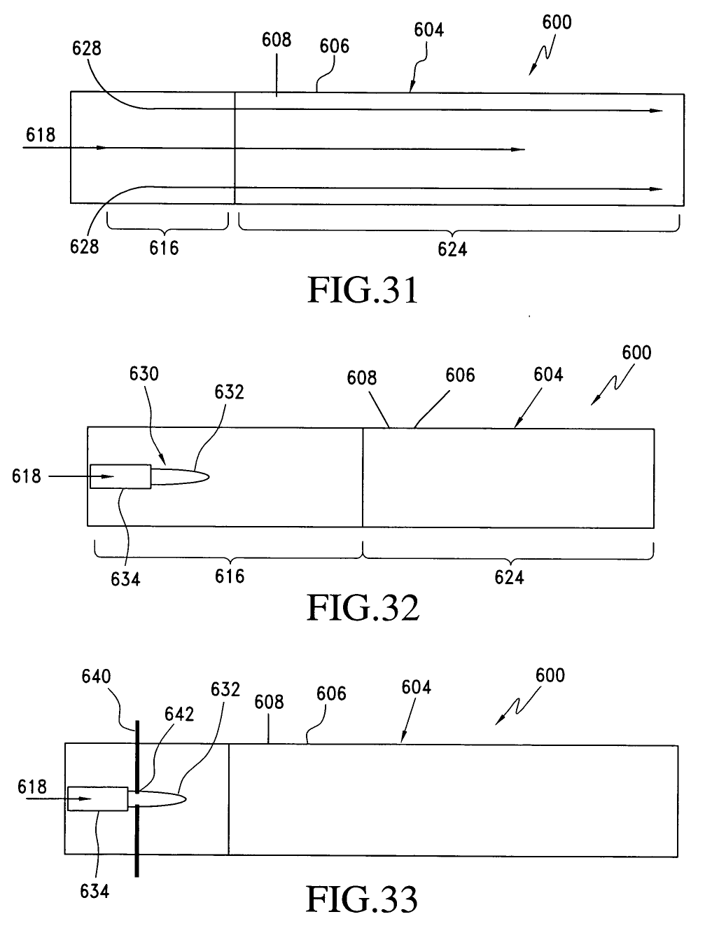

FIG. 31 shows a flame reactor 600 that includes a feature for reducing or eliminating thermophoretic losses. Flame reactor 600 comprises a conduit 604, the conduit 604 including a wall 606 with an inside surface 608. Flame reactor 600 includes a primary zone 616 into which a feed 618 is introduced. Feed 618 includes a nongaseous precursor material that includes a component for inclusion in nanoparticulates. Within primary zone 616, nanoparticulates including the component are nucleated and formed in a flowing stream. The flowing stream flows from primary zone 616 into secondary zone 624. Within secondary zone 624, the nanoparticulates are grown into a desired weight average particle size, such as during the growing nanoparticulates previously described above. Flame reactor 600 also includes feed 628 of a barrier gas that is introduced into flame reactor 600 in order to prevent or inhibit thermophoretic losses. Feed 628 is introduced to create a barrier all around the inside surface 608 of conduit 604 to prevent nanoparticulates from contacting and depositing on inside surface 608. Preferably, feed 628 is introduced into flame reactor 600 with sufficient velocity to carry any nanoparticulates that may migrate towards inside surface 608 out of secondary zone 624 prior to being deposited on inside surface 608. Additionally, feed 628 is preferably heated to a temperature above the temperature of inside surface 608 in order to reduce the temperature difference between the inside surface 608 and the flowing stream in secondary zone 624, which will reduce the tendency of nanoparticulates to migrate toward inside surface 608. In some embodiments, the temperature of feed 628 may be the same as the temperature of the nanoparticulates in the flowing stream. In other cases, the barrier gas may have a temperature that is higher than the nanoparticulates in the flowing stream. It is important to note that the effectiveness of feed 628 in inhibiting or preventing thermophoretic losses is in the combination of it velocity to carry nanoparticulates out of secondary zone 624 and in its temperature to reduce the tendency of the nanoparticulates to migrate toward inside surface 308.

FIG. 32 shows flame reactor 600, which includes a different feature for avoiding or inhibiting thermophoretic losses. In addition to the other parts previously described, flame reactor 600 includes a feed 630 of a barrier gas that is introduced into flame reactor 600 so that it spirals around a flame 632 being generated by a burner 634. By spiraling around flame 632, feed 630 focuses flame 632 and the flowing stream in primary zone 616. Also, nanopaticulates that form in the flowing stream will be focused into a center axis of conduit 604. The focusing effect of spiraling feed 630 is maintained throughout primary zone 616 and into secondary zone 624. Consequently, the focusing effect will inhibit the migration of nanoparticulates toward inside surface 608 and reduce or eliminate the thermophoretic losses within secondary zone 624. More than one feed 630 may be introduced into primary zone 616 and around flame 632. For example, there may be three or four ports or jets that inject feed 630 around flame 632, and help create the spiraling effect that prevents or inhibits thermophoretic losses.

The barrier gas used in flame reactors to avoid thermophoretic losses of nanoparticulates may have any composition. In most cases, the barrier gas is merely functioning to prevent deposition of nanoparticulates onto inside surface 608, and thus will be inert. However, in some cases, the barrier gas may include a component for inclusion in the nanoparticulates. The component may be derived from a precursor such as those previously described above, which may be gaseous, nongaseous or a combination thereof. The component for inclusion in the nanoparticulates in feed 630 may be included in the nanoparticulates when the nanoparticulates are nucleated and formed within primary zone 616 or when the nanoparticulates are growing in secondary zone 624.

Some examples of compositions of barrier gas that may be used in feeds 628 and 630 shown in FIGS. 31 and 32 include oxygen, nitrogen, hydrogen, inert gases (such as helium, neon, argon, krypton, xenon, and radon) and combinations of gases such as air. Also, as previously mentioned, the barrier gas may also include precursors. Some examples of precursors that may be included in the barrier gas are those that have previously been described above.

In addition to the use of a barrier gas to avoid or inhibit thermophoretic losses, flame reactors used with the method of the present invention may also include a feature that heats the wall(s) of a flame reactor or the volume near the wall(s) of a flame reactor to reduce or eliminate the difference in temperature between the nanoparticulates in a flame reactor and the wall(s) of a flame reactor, thus reducing or eliminating the tendency of the nanoparticulates to migrate toward the wall(s). The previously described flame reactors shown in FIGS. 8-11 are useful designs for heating the wall(s) or the volume near the wall(s) of a flame reactor and consequently preventing or reducing thermophoretic losses. For example, in FIG. 8 the heating element 142 may be used to raise the temperature of a wall of conduit 108, which forms flame reactor 106 to a temperature where the difference in temperature between the wall and the nanoparticulates in flame reactor 106 is small enough to reduce the tendency of the nanoparticulates to migrate toward the wall. With respect to flame reactor 106 in FIG. 9, the plurality of flames 146 may be used to create a hot region in the flame reactor 106 adjacent the wall of conduit 108; the hot region being at a temperature where the difference in temperature between the hot region and the nanoparticulates in flame reactor 106 is small enough to reduce the tendency of the nanoparticulates to migrate toward the hot region and the wall. Similarly, in FIG. 10, side flames 150 may also be used to create a hot region along a wall of conduit 106. It is important to note that it is not necessary that the temperature of a reactor wall(s) or a hot region adjacent a reactor wall(s) be at or above the temperature of the nanoparticulates in the flame reactor, although it may. The purpose of heating the wall(s) of a flame reactor or creating a hot region adjacent a wall(s) is to allow the nanoparticulates to remain within the flame reactor for a period of time that is necessary to completely process the nanoparticulates without losing a significant amount of nanoparticulates to thermophoretic losses. Thus, the temperature of a flame reactor wall may be at any temperature that accomplishes this result. In some cases the flame reactor will have a feature that maintains the wall(s) of the flame reactor at a temperature greater than the temperature of the nanoparticulates. In this embodiment, because the temperature of the wall is greater than the temperature of the nanoparticulates, the nanoparticulates will be repelled from the wall of the flame reactor and there will be no thermophoretic losses.

In some embodiments of the present invention, one consideration that is important in preventing thermophoretic losses is the ratio of: a flame's maximum cross-sectional area perpendicular to the direction of flow through the flame, to the internal cross-sectional area perpendicular to the direction of flow through the flame reactor. This is an important consideration because in those embodiments where the nanoparticulates are formed in the flame, the ratio will reflect the distance that the nanoparticulates must travel before being deposited on the inside surface of a flame reactor. Thus, it is desirable to have the flame area significantly smaller than the flame reactor area to reduce the thermophoretic losses of the nanoparticulates by increasing the distance they must travel before being deposited on the inside surface of a flame reactor. Accordingly, the ratio of the internal cross-sectional area of the conduit to the maximum cross-sectional area of the flame is preferably at least 2 and more preferably at least 4, with the areas being determined in a plane perpendicular to the direction of flow. The ratio may be within the range of 1.5 to 10.

FIG. 33 shows another embodiment of a flame reactor 600 that is useful in reducing or inhibiting thermophoretic losses within flame reactor 600. In addition to the parts previously described, flame reactor 600 includes a wall 640 with an aperture 642. Wall 640 is constructed in a way that allows the aperture 642 to be controllably adjusted to various diameters. As can be seen in FIG. 33, flame 632 is disposed within aperture 642. The aperture 642 and wall 640 operate to focus flame 632 and maintain the diameter of flame 632 the same as the diameter of aperture 642. The focusing of flame 632 by wall 640 and aperture 642 reduces the cross sectional area, discussed above, of flame 632. As previously stated above, a smaller cross-section area of the flame, increases the distance that a nanoparticulate formed within flame 632 must travel before being deposited on the inside surface 608 of conduit 604. Thus, the nanoparticulates may be held within flame reactor 600 for a longer residence time without incurring significant thermophoretic losses, than otherwise is possible without wall 640 and aperture 642.

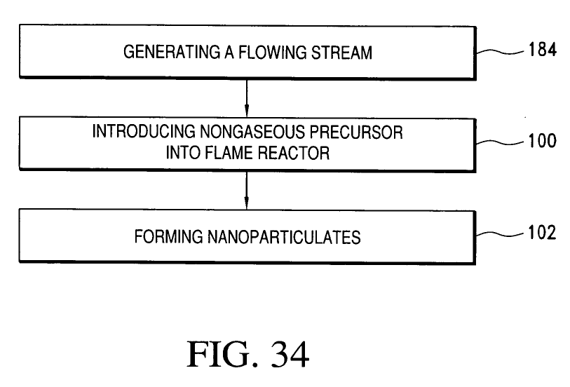

The wall 640 may be made of any suitable material for use in a flame reactor. As can be seen in FIG. 34, the wall 640 will be subjected to the high temperatures of flame 632 and is therefore preferably made of materials that can withstand temperatures that are at least as high as the temperature of flame 632. Some examples of materials include refractory metals, ceramics or composite materials that include metals and ceramics. The materials previously described with respect to the appropriate materials for a conduit, are applicable for use in construction of wall 640. As previously described, the aperture 642 is preferably adjustable to any desired or diameter. In one specific embodiment, the wall 640 may be made of several pieces of material that are overlapped with respect to one another and are movable with respect to one another to change the diameter of aperture 642.

Another feature useful to inhibit thermophoretic losses for use with the present invention is to have a mirror finish on the interior surface of the flame reactor. By “mirror finish” it is meant a highly reflective surface. The mirror finish reduces thermophoretic losses by reducing the surface area available for nanoparticulates to deposit and adhere.

An additional consideration in performing the methods of the present invention include control of the flame characteristics used in forming the nanoparticulates. The characteristics of the flame may affect the efficiency of the process, production rate of nanoparticulates, and the properties of the nanoparticulates. The previous descriptions with respect to the various burners that may be used in flame reactors for performing the methods of the present invention and the combinations of feeds introduced into the burners are applicable for controlling the characteristics of the flames. For example, the burners shown in FIGS. 23-28 allow control over the shape of the flames and consequently the temperature profile within the flames. For example, with respect to slot burner 300 shown in FIG. 24, the uniform shape of flame sheet 306 allows nanoparticulates that are made within any portion of flame sheet 306 to have generally the same properties and characteristics. It should be noted that in some cases it might be preferable to have flames with less uniform shapes. In those particular cases, typical cylindrical flames may be appropriate for use in making nanoparticulates.

In addition to the shape of the flames, which may help control temperature profiles, it is also possible to control the feeds introduced into a burner. One example of an important control is the ratio of fuel to oxidant that is fed into a flame. In some embodiments, the nanoparticulates or the precursors introduced into a flame may be easily oxidized, and it may be desirable to maintain the fuel to oxidant ratio at a fuel rich ratio to ensure that no excess oxygen is introduced into the flame. Some materials that are preferably made in a flame that is fuel rich include materials such as metals, nitrides, and carbides. The fuel rich environment ensures that all of the oxygen that is introduced into a flame will be combusted and there will be no excess oxygen available in the flame reactor to oxidize the nanoparticulates or precursors. In other embodiments, it may be desirable to have a fuel to oxidant ratio that is rich in oxygen. For example, when making metal oxide ceramics, it may be desirable to maintain the environment within a flame and in the flame reactor with excess oxygen. In yet other embodiments, the fuel to oxygen ratio introduced into the flame may not be an important consideration in processing the nanoparticulates.

In addition to the environment within the flame and the flame reactor, the fuel to oxidant ratio also controls other aspects of the flame. One particular aspect that is controlled by the flame is the flame temperature. If the fuel to oxidant ratio is at a fuel rich ratio then the flame reactor will contain fuel that is not combusted. Unreacted fuel obviously generates a flame that is at a lower temperature than if all of the fuel that is provided to the flame reactor is combusted. Thus, in those situations in which it is desirable to have all of the fuel combusted in order to maintain the temperature of a flame at a high temperature, it will be desirable to provide to the flame reactor excess oxidant to ensure that all of the fuel provided to the flame or flame reactor is combusted. However, if it is desirable to maintain the temperature of the flame at a lower temperature, than the fuel to oxidant ratio may be fuel rich so that only an amount of fuel is combusted so that the flame does not exceed a desired temperature.

The specific type of fuel will also affect the temperature of a flame. In addition to the temperature of the flame, the selection of a fuel may involve other considerations Fuels that are used to combust and create the flame may be gaseous or non-gaseous. The non-gaseous fuels may be a liquid, solid or a combination of the two. In some cases, the fuel combusted to form the flame may also function as a solvent for the nongaseous precursor. For example, a liquid fuel may be used to dissolve a nongaseous precursor and be fed into a burner as dispersed droplets of the liquid containing the dissolved nongaseous precursor. In other embodiments, the liquid fuel may be useful as a solvent for the precursor but not contain enough energy to generate the required heat within the flame reactor for all of the necessary reactions. In this case, the liquid fuel may be supplemented with another liquid fuel and/or a gaseous fuel, which are combusted to contribute additional heat to the flame reactor. Nonlimiting examples of gaseous fuels that may be used with the method of the present invention include methane, propane, butane, hydrogen and acetylene. Some nonlimiting examples of liquid fuels which may be used with the method of the present invention include alcohols, toluene, acetone, isooctane, acids and heavier hydrocarbons such as kerosene and diesel.

As noted above t in some cases the fuel will be a combination of liquids. This embodiment is useful in situations when it is desirable to dissolve the nongaseous precursor into a liquid to disperse the nongaseous precursor. However, the nongaseous precursor may only be soluble in liquids that are low energy fuels. In this case, the low energy fuel may be used to dissolve the nongaseous precursor, while an additional higher energy fuel may supplement the low energy fuel to generate the necessary heat within the flame reactor. In some instances, the two liquid fuels may not be completely soluble in one another, in which case the liquid will be a multiphase liquid with two phases (i.e., an emulsion). In other instances the two liquids may be mutually soluble in each other and form a single phase. It should be noted that in other cases there may be more than two liquid fuels introduced into the flame, the liquids may be completely soluble in one another or may be in the form of an emulsion. It should also be noted that the nongasoues precursor that is introduced into the flame reactor might also, in addition to containing the component for inclusion in the nanoparticulates, act as a fuel and combust to generate heat within the flame reactor.

The oxidant used in the method of the present invention to combust with the fuel to form the flame may be a gaseous oxidant or a nongaseous oxidant. The nongaseous oxidant may be a liquid, a solid or a combination of the two. However, preferably the oxidant is a gaseous oxidant and will typically be oxygen. The oxygen may be introduced into the flame reactor substantially free of other gases such as a stream of substantially pure oxygen gas. In other cases, the oxygen will be introduced into the flame reactor with a mixture of other gases such as nitrogen, as is the case when using air. Although it is preferable to have a gaseous oxidant, in some cases the oxidant may be a liquid. Some examples of liquids that may be used as oxidants include inorganic acids. Also, the oxidant that is introduced into the flame reactor may be a combination of a gaseous oxidant or a liquid oxidant. This may be the case when it is desirable to have the nongaseous precursor dissolved in a liquid to disperse it, and it also desirable to have the oxidant located very close to the nongaseous precursor when in the flame reactor. In this case, the precursor may be dissolved in a liquid solvent that functions as an oxidant.

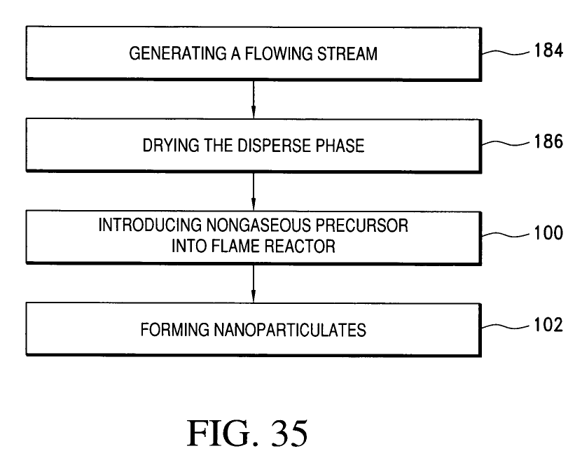

As previously described, the method of the present invention includes introducing a nongaseous precursor into a flame reactor. The method of the present invention may also include providing, a flowing stream with a disperse phase including the nongaseous precursor and a gas phase, prior to the introducing the nongaseous precursor step. FIG. 34 shows a generalized process block diagram of another embodiment of the method of the present invention. The block diagram shown in FIG. 35 includes a generating 184 a flowing stream for feed to the flame reactor during the introducing 100. The generating 184 may involve a number of steps, depending on the materials to be included in the flowing stream.

In one embodiment, the disperse phase of the flowing stream includes a liquid, the liquid containing the dissolved nongaseous precursor, which includes the component for inclusion in the nanoparticulates. In this embodiment, the generating 184 includes steps for dispersing the liquid into droplets within the gas phase. This may be performed using any suitable device that disperses liquid into droplets, such as for example, a nozzle. The nozzle may be any nozzle which is useful for dispersing liquids into droplets. Some examples include ultrasonic nozzles, multi-fluid nozzles and pressurized nozzles.

Ultrasonic nozzles generate droplets of liquid by using piezoelectric materials that vibrate at ultrasonic frequencies to break up a liquid into small droplets. Pressurized nozzles use pressure and a separator or screen in order to break up the liquid into droplets. In some cases, pressurized nozzles may involve use of some vapor that is generated from the liquid itself in order to pressurize and break up the liquid into droplets. One advantage of using ultrasonic and pressurized nozzles is that an additional fluid is not required to generate liquid droplets. This may be useful in situations where the nongaseous precursor dissolved in the liquid is sensitive and/or incompatible with other common fluids used in multi-fluid nozzles, described in detail below.

Multi-fluid nozzles use more than one fluid to generate droplets of a liquid, typically two or three fluids. In a two-fluid nozzle, a gaseous feed and a liquid feed are introduced into the nozzel, and the gaseous feed is used to break up the liquid feed into droplets. Similarly, in a three-fluid nozzle three fluids are introduced into the nozzle, at least one fluid being a gas in order to break up the liquid or liquids into droplets.

The use of multi-fluid nozzles is particularly advantageous in some embodiments of the method of the present invention. With reference once again to FIG. 34, during the generating 184, it may be desirable to generate the flowing stream to include in addition to the nongaseous precursor, a fuel and/or an oxidant. This may be done by using a multi-fluid nozzle—either a two-fluid nozzle or a three-fluid nozzle. A two-fluid nozzle may be used by introducing a feed of liquid which contains a dissolved or suspended nongaseous precursor and a feed of a gaseous oxidant, gaseous fuel, additional gaseous precursor or a combination thereof to break up the liquid into droplets. In this embodiment, the flowing stream that is generated during the generating 184 will include the nongaseous precursor dissolved in the liquid droplets and the gas phase will include a gaseous oxidant, a gaseous fuel, a gaseous precursor or combination thereof.

In another embodiment, a three-fluid nozzle may be used during the generating 184 to generate a flowing stream that includes the nongaseous precursor. Using a three-fluid nozzle, a liquid with the nongaseous precursor dissolved or suspended therein is fed into the three-fluid nozzle along with a feed of gaseous oxidant and a feed of gaseous fuel to break up the liquid into droplets. Within the three-fluid nozzle, the gaseous oxidant and the gaseous fuel will mix so that the flowing stream that is formed from the generating 184 will include a disperse liquid phase including the nongaseous precursor and a gas phase including the gaseous oxidant and gaseous fuel.

In another embodiment, the use of three fluids in a three-fluid nozzle may be useful for generating a flowing stream that has at least two disperse liquid phases each containing a nongaseous precursor that includes a component for inclusion in the nanoparticulates. In this example, a first liquid feed that includes a first precursor is introduced into the nozzle along with a second feed containing a second precursor and a gaseous feed. The gaseous feed may be a fuel, an oxidant, an additional precursor, an inert gas or a combination of the foregoing. This embodiment may be particularly useful for generating a flowing stream that includes multiple precursors that are soluble in vastly different solvents. This embodiment advantageously allows incompatible precursors or solvents to be mixed for only a short period of time within the nozzle before they are included as disperse phases in the flowing stream.

In another embodiment of the present invention, a three-fluid nozzle is used to introduce at least one liquid fuel into the flowing stream generated during the generating 184. In this embodiment, a first liquid which includes a nongaseous precursor is fed into the nozzle, a second liquid which includes a liquid fuel is also introduced into the nozzle and a gaseous feed is introduced into the nozzle. The gaseous feed may be an oxidant, a fuel, include a gaseous precursor, an inert gas or a combination of the foregoing. Additionally, the liquid in which the nongaseous precursor is dissolved or suspended may be an additional fuel or oxidant.

In addition to the use of a nozzle for dispersing liquid containing the nongaseous precursor, any other suitable device or apparatus for generating disperse droplets of liquid may be used in the generating 184. One example of a device that is useful in generating droplets of liquid is an ultrasonic generator. An ultrasonic generator uses transducers to vibrate liquids at very high frequencies which breaks up the liquid into droplets. One example of an ultrasonic generator that is useful with the present invention is disclosed in U.S. Pat. No. 6,339,809, referenced previously.

In one embodiment, a high-velocity flowing stream may be used to atomize a liquid feed. FIG. 39 shows an example of such atomization that uses combustion gases for generating droplets of liquid is shown in FIG. 39. FIG. 39 shows a flame reactor 700, which includes a conduit 702. Flame reactor 700 includes a primary zone 704, and within the primary zone 704 is a burner 706 through which an oxidant and a fuel are fed and combusted to generate a flame 708. Hot combustion gases discharged from flame 708 are directed to and flow through a restricted portion 710 of conduit 702. The restricted portion 710 has a smaller cross-sectional area available for flow, and so the velocity of the flowing stream through the restricted portion 710 is much higher than upstream or downstream of the restricted portion 710. Preferably, the velocity of the flowing stream through the restricted portion 710 is near sonic velocity. A feed 712 of liquid is introduced into the hot gases of the flowing stream in the restricted portion 710. The high energy of the flowing stream breaks up the feed 712, thereby atomizing the liquid into droplets. Because the flowing stream is very hot in the restricted portion 710, the droplets quickly vaporize and nanoparticulate formation proceeds.

In another embodiment, the flowing stream includes a solid disperse phase that includes the nongaseous precursor. In this embodiment, the generating 184 will involve a step or process of introducing solid materials into a gas phase. Any device that is useful for introducing solid particulate materials into a gas phase may be used in this embodiment. In one example, a jet mill may be used to aerosolize or to disperse in a gas phase a solid particulate material that includes the nongaseous precursor. As previously stated, the term solid material is not meant to be limited to crystalline materials but may also include amorphous materials such as glasses.

The generating 184 may include the use of more than one of the previously described devices for dispersing liquids and/or solids in a gas phase. In one implementation of this embodiment, two streams are generated that include different disperse phases. A first stream may be generated with a first disperse phase dispersed in a gas phase, and a second stream may be generated that includes a second disperse phase in a gas phase. The gas phases may be the same or may be different. In one embodiment, the first disperse phase may be a liquid that includes the nongaseous precursor having a component for inclusion in the nanoparticulates. The second disperse phase may also be a liquid which includes a second nongaseous precursor having a second component for inclusion in the nanoparticulates. In this case, the generating 184 may include a mixing step in which the first stream that includes the first disperse phase and the second stream including the second disperse phase may be mixed to form a single flowing stream that contains multiple disperse phases, each disperse phase including a different precursor material having a component for inclusion in the nanoparticulates. In other embodiments, both dispersed phases in the first stream and the second stream may be solid materials. In yet other embodiments, only one of the first disperse phase and the second disperse phase may be a solid and the other one may be a liquid. The disperse phases that are formed in the first flowing stream and the second flowing stream may be generated using any of the previously described methods for forming a solid or liquid disperse phase.

In another embodiment, the generating 184 includes mixing two different streams that contain two different disperse phases only one of the disperse phases containing a nongaseous precursor. In this embodiment, a first stream includes a disperse phase with a nongaseous precursor that has a component for inclusion in the nanoparticulates. The second flowing stream includes a disperse phase that does not include a precursor, but may include a fuel, oxidant, a combination of a fuel and an oxidant or another material. In one specific embodiment, the disperse phase in the second stream includes a liquid fuel that is used to combust with an oxidant and generate heat in the flame reactor.

In another specific example, the second stream includes a disperse phase with a heat absorber. This embodiment of the present invention advantageously allows additional control of the temperature within the flame reactor. The heat absorber may be used to lower the temperature of the flame reactor or a flame and control the temperature within the flame reactor's primary zone or within a flame. Any suitable material that absorbs heat without interfering with the formation of the nanoparticulates including any reactions necessary to form the nanoparticulates may be used as the heat absorber. One preferable heat absorbing material is water. Water advantageously has a large latent heat of vaporization, which means that it can absorb a large amount of heat when being converted into steam. Also, water is inexpensive, easily dispersible, and inert with respect to the materials that will typically be within the flame reactor. Although water is a preferred heat absorbing material, the present invention is not limited thereto. In other embodiments, the heat absorbing materials may be other solid or liquid material that absorb desired heat from the flame reactor, or a flame without interfering with formation of the nanoparticulates.

FIG. 35 shows another embodiment of the method of the present invention which includes drying 186 the disperse phase after the generating 184 and before the introducing 100. The drying 186 includes removing liquid that is present in the disperse phase of the flowing stream into the gas phase of the flowing stream. The drying 186 may be performed using any suitable device for removing liquid from a disperse phase and into a gas phase. Typically, the drying 186 will be performed by using a heater to heat the flowing stream so that any liquid in the disperse phase evaporates into the gas phase.

The heating of the flowing stream may be accomplished in ally suitable fashion. Some nonlimiting examples including directing the flowing stream into a heater, which heats the flowing stream using electric heating elements. In another example, the heater may be heat the flowing stream using one or more flames. Additionally, the heater may be heated by using microwaves, plasma, or a monochromatic beam of light (i.e., laser).

Additionally, instead of use of a heater, the flowing stream may be directed into a low pressure environment that will evaporate any liquid in the disperse phase into the gas phase. The low pressure environment may be, for example, a chamber with a vacuum pump that creates a vacuum within the chamber. In another example, the flowing stream may be directed into a chamber with a very large volume, which allows any gases to expand reducing the pressure and evaporating any liquid from the disperse phase into the gas phase. These are merely two examples, and any method or device for vaporizing or evaporating liquid from the disperse phase into the gas phase may be used during the drying 186.

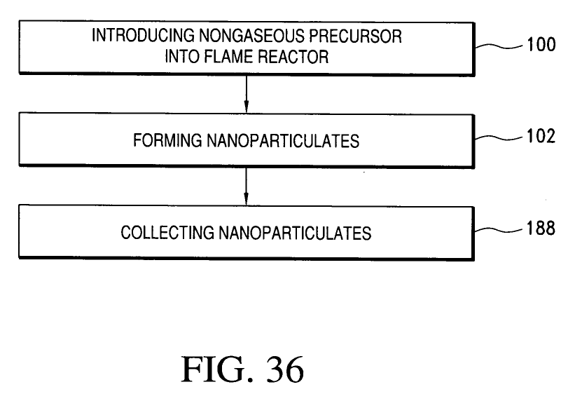

FIG. 36 shows a generalized process diagram of another embodiment of the method of the present invention, which includes a collecting nanoparticulates step 188. The collecting nanoparticulates step 188 includes separating the nanoparticulates after the forming 102. The collecting nanoparticulates may be performed using any suitable methods or devices for separating solid particulate materials from gases.

In one embodiment of the method shown in FIG. 36, the nanoparticulates are collected dry. In this embodiment, the collecting nanoparticulates 188 may be performed for example, using filters, such as a bag house or an electrostatic precipitator. Electrostatic precipitators are commonly used in collecting small particles and are a preferred device for performing the collecting nanoparticulates step 188 when the collecting nanoparticulates step 188 is performed to collect the nanoparticulates dry.

In other embodiments, the nanoparticulates may be collected using a collection liquid. Any suitable device or method for separating solid particulates from gases using a collection liquid may be used with this embodiment of the present invention. Some nonlimiting examples of devices that may be used in this embodiment include venturi scrubbers, which use a spray of collection liquid to separate nanoparticulates from a gas. A wet wall may also be used to separate the nanoparticulates from gases. The nanparticulates may be passed through a wall of liquid, so that the nanopartiuclates are captured by the liquid while the gases flow through the wet wall. In another embodiment, a wet electrostatic precipitator which works similar to the electrostatic precipitator previously discussed but includes a wet wall where the nanoparticulates are collected is used to perform the collecting nanoparticulates 188. In yet another example, the nanoparticulates may be collected in a liquid bath. The flowing stream containing the nanoparticulates may be directed into or bubbled through a bath of collection liquid, where the nanoparticulate will be collected and the gases will flow through the liquid. These are intended only to be some nonlimiting examples of devices and methods by which the nanoparticulates may be collected using a collecting liquid.

The use of a collecting liquid for performing the collecting nanoparticulates 188 provides a variety of advantages. In one specific embodiment of the present invention, the collecting liquid used in collecting the nanoparticulates 188 contains a surface modifying material. By the term “surface modifying material”, it is meant a material that interacts with the surface of the nanoparticulates to change the properties of the surface of the nanoparticulates. For example, the surface modifying material may deposit material onto the surface of the nanoparticulates, bond surface groups to the nanoparticulates or associate materials with the surface of the nanoparticulates. In other cases, the surface modifying material may remove material from the nanoparticulates, such as by removing surface groups or by etching material from the surface of the nanopaticulates.

In one embodiment, the surface modifying material will interact with the nanoparticulates to prevent the nanoparticulates from sticking together, in other words, the surface modifying material allows the nanoparticulates to remain in a disperse state while in the collection liquid and to easily disperse the nanoparticulates for use in a final application. In some embodiments, the surface modifying material may deposit around the entire outside surface of the nanoparticulates to prevent the nanoparticulates from sticking together. In other embodiment, the surface modifying material may simply associate the surface of the nanoparticulates in a way that keeps them dispersed. Some examples of surface modifying materials which may be included in the collection liquid include surfactants, such as ionic surfactants, non-ionic surfactants and ionic surfactants and dispersants.

In some cases, the surface modifying material may not deposit onto the surface of the nanoparticulates or associate with the surface of the nanoparticulates but rather may remove material from the surface of the nanoparticulates. For example, if there are materials that were present within the flame reactor that are deposited onto the surface of the nanoparticulates, but it is desirable to remove those materials prior to use of the nanoparticulates in a final application, the collection liquid may include a surface modifying material that removes the unwanted material from the surface of the nanoparticulates. In other cases, it may be desirable for a final application to increase the specific surface area of the nanoparticulates. In this embodiment, the collection liquid may include a surface modifying material that will slightly etch or remove material from the surface of the nanoparticulates in order to increase the specific surface area of the nanoparticulates.

In addition to a surface modifying material, the collection liquid may contain a precursor that includes a component for inclusion in the nanoparticulates. In this embodiment, the collection liquid may be processed with the nanoparticulates suspended in the collection liquid through a process that will include the component of the collection liquid in the nanoparticulates. For example, the collection liquid, with the nanoparticulates suspend in the liquid, may be dispersed in a gas phase to form a flowing stream that is introduced into a reactor, where the component is included in the nanoparticulates. The reactor may be a flame reactor or other suitable reactor.

Any feature described or claimed with respect to any disclosed implementation may be combined in any combination with any one or more other feature(s) described or claimed with respect to any other disclosed implementation or implementations, to the extent that the features are not necessarily technically incompatible, and all such combinations are within the scope of the present invention. Without limiting the general applicability of the foregoing, any one or more of the steps of introducing 100, forming 102, generating 184, drying 186 and collecting 188 described with respect to any one or more of the figures may be combined in any combination with any one or more of the same or other of such steps, whether or not any such specific combination is expressly disclosed herein. Moreover, any additional steps may be added before or after any such step, or between any such steps, provided that the combination is not necessarily technically incompatible. Also, the forming 100 may include in any combination any one or more than one of the transferring, quenching, growing and modifying operations shown in any of the figures or otherwise described herein, whether or not any such specific combination is expressly described herein. Also, any feature or more than one features of any of the implementations of flame reactor 106, 200, 600 or 700 described with respect to any figure may be combined in any combination with any one feature or more that one features of any one or more other implementations of flame reactor 106, 200, 600 and 700 described with respect to any other figure or figures and/or with any feature or features of any of burner 300, 400 or 500 described with respect to shown in any figure. Furthermore, the claims appended below set forth some nonlimiting combinations of features within the scope of the invention, but also contemplated as being within the scope of the invention are all possible combinations of the subject matter of any two or more of the claims, in any possible combination, provided that the combination is not necessarily technically incompatible.

The terms “comprise”, “include”, “have” and “contain”, and variations of those terms, are intended to indicate only that a particular feature or attribute is present, and are not intended to limit the presence of other features or attributes.

### EXAMPLES

The present invention is further described with reference to the following non-limiting examples.

### Example 1

### Synthesis of Cerium Yttrium Aluminum Garnet (YAG) Powder

Cerium 2-ethylhexanoate, yttrium 2-ethylhexanoate, and aluminum diisopropoxide ethylacetoacetate mixed with toluene is used as the precursor solution for the synthesis of ceria doped YAG powder. The metal weight percent of cerium, yttrium, and aluminum in the precursor solution are 0.1, 3, and 1.5 respectively. The precursor flow rate and dispersing oxygen flow rate were 15 ml/min and 25 SLPM, respectively. The surface area of particles varied from 66 m²/gm to 71 m²/gm. The scanning electron microscopy (SEM) and tunneling electron microscopy (TEM) analysis shows that particles are non-agglomerated with the primary particle size varying from 10 to 75 nm. The quasi-elastic light scattering analysis using a Malvern instrument showed that intensity average particle size is 176 nm when a lower temperature reactor was used, and the intensity average particle size of 150.1 nm when higher temperature reactor was used. The synthesized ceria YAG powders can be used as a light emitting diode (LED) phosphor.

### Example 2

### Synthesis of Europium Doped Yttria Powder

Europium 2-ethylhexanoate, and yttrium 2-ethylhexanoate mixed with toluene is used as the precursor solution for the synthesis of europium doped yttria powder. The metal weight percent of europium, and yttrium in the precursor solution are 0.5 and 3.4 respectively. The precursor flow rate and dispersing oxygen flow rate were 15 ml/min and 25 SLPM, respectively. The surface area of particles varied from 45 m²/gm to 63 m²/gm. The SEM and TEM analysis shows that particles are crystalline and mostly non-agglomerated with the primary particle size varying from 10 to 40 nm. The quasi-elastic light scattering analysis using a Malvern instrument showed that intensity average particle size is 198.7 nm when lower temperature reactor was used, and the intensity average particle size of 146.8 nm when higher temperature reactor was used. The synthesized europium doped yttria powders can be used as a phosphor.

### Example 3

### Synthesis of Zinc Oxide Powders

Zinc 2-ethylhexanoate mixed with toluene is used as the precursor solution for the synthesis of zinc oxide powder. The metal weight percent of zinc in the precursor solution varied from 5.1 to 5.4. The precursor flow rate and dispersing oxygen flow rate were 15 ml/min and 25 SLPM. The surface area of particles varied from 26 m²/gm when lower temperature reactor was used to 28 m²/gm when higher temperature reactor was used. The SEM analysis shows that particles are rod shape and mostly non-agglomerated with the primary particle size varying from 20 to 200 nm. The quasi-elastic light scattering analysis using a Malvern instrument shows that intensity average particle size is 230.1 nm. The synthesized zinc oxide powders can be used in cosmetics, and as variable resistors in solar cells.

What is claimed is:

1. A method of making nanoparticulates comprising a low-melting temperature material having a melting temperature of less than 2000° C., the method comprising:
introducing into a flame reactor heated by at least one flame a nongaseous precursor including a component for inclusion in the low-melting temperature material of the nanoparticulates; and
after the introducing, forming the nanoparticulates, the forming comprising transferring substantially the entire component through a gas phase of a flowing stream in the flame reactor and growing the nanoparticulates in the flowing stream to a weight average particle size less than about 500 nanometers.

2. The method of claim 1, wherein the growing comprises agglomerating individual nanoparticles.

3. The method of claim 1, wherein the growing comprises coalescing individual nanoparticles.

4. The method of claim 1, wherein the growing comprises nucleation and condensation.

5. The method of claim 1, wherein the upper limit of the weight average particle size range is 200 nm.

6. The method of claim 1, wherein the residence time of the flowing stream during the growing is at least 0.1 second.

7. The method of claim 1, wherein the temperature of the flowing stream during the growing is in a range of from a first temperature of at least a sintering temperature of the low-melting temperature material to a second temperature that is higher than the first temperature, wherein the second temperature is a boiling temperature of the low-melting temperature material or, when the low-melting temperature material decomposes prior to boiling, the decomposition temperature of the low-melting temperature material.

8. The method of claim 1, wherein during the growing, the flowing stream comprises ions that limit growth of the nanoparticulates.

9. The method of claim 1, wherein the nanoparticulates are of spheroidal shape.

10. The method of claim 1, wherein the nanoparticulates exiting the growing are substantially unagglomerated.

11. The method of claim 1, wherein during the introducing, at least a portion of the nongaseous precursor is introduced into the reactor in admixture with fuel for combustion in the flame.

12. The method of claim 1, wherein during the introducing, at least a portion of the nongaseous precursor is introduced into the reactor in admixture with oxidant for combustion in the flame.

13. The method of claim 1, wherein during the introducing, at least a portion of the nongaseous precursor is contained in a nongaseous disperse phase when introduced into the flame reactor.

14. The method of claim 13, wherein the disperse phase comprises droplets comprising the nongaseous precursor and liquid.

15. The method of claim 14, wherein the nongaseous precursor in the droplets is dissolved in the liquid.

16. The method of claim 14, wherein the droplets further comprise fuel for combustion in the flame.

17. The method of claim 16, wherein the liquid comprises water and the fuel comprises a water-soluble organic.

18. The method of claim 16, wherein the liquid is substantially entirely organic.

19. The method of claim 16, wherein the fuel comprises an organic material selected from the group consisting of alcohols, aldehydes, ketones, ethers, glycols, toluene, isooctane, carboxylic acids, waxes and fuel oils.

20. The method of claim 14, wherein the droplets comprise oxidant for combustion in the flame.

21. The method of claim 14, comprising prior to the introducing, generating the droplets.

22. The method of claim 21, wherein the generating comprises forming a gas dispersion comprising the droplets as a disperse phase; and the introducing comprises introducing the gas dispersion into the flame reactor.

23. The method of claim 22, wherein a gas phase of the gas dispersion comprises fuel for combustion in the flame.

24. The method of claim 22, wherein the gas phase of the gas dispersion comprises oxidant for combustion in the flame.

25. The method of claim 21, wherein the gas dispersion is formed from an ultrasonic aerosol generator comprising a reservoir of liquid feed ultrasonically energized by one or more ultrasonic transducers underlying the reservoir.

26. The method of claim 22, wherein the gas dispersion, as introduced into the flame reactor, comprises at least 0.25 cubic centimeters of the disperse phase per liter of the gas dispersion.

27. The method of claim 1, wherein during the introducing, at least a portion of the nongaseous precursor is introduced into the flame and at least another portion of the nongaseous precursor is introduced into the flame reactor downstream of the flame into hot gas comprising combustion product from the flame.

28. The method of claim 1, wherein the flame is one of a plurality of flames of the flame reactor; and during the introducing a different portion of the nongaseous precursor is introduced into each of two or more of the plurality of flames.

29. The method of claim 1, wherein the nanoparticulates are multi-phase particles comprising the low-melting temperature material as a first phase and comprising a different second phase; the nongaseous precursor is a first precursor and the component is a first component; and the introducing comprises introducing a second precursor into the flame reactor, the second precursor including a second component for inclusion in the second material phase of the nanoparticulates; and wherein the second precursor is nongaseous and the forming comprises transferring substantially the entire second component through the gas phase of the flowing stream.

30. The method of claim 29, wherein during the introducing, at least a portion of the first precursor and at least a portion of the second precursor are introduced into the flame reactor together in a single feed.

31. The method of claim 29, wherein the nanoparticulates comprise one of the first phase and the second phase as a matrix and the other of the first phase and the second phase is a disperse phase that is dispersed in the matrix.

32. The method of claim 29, wherein one of the first phase and the second phase is metal and the other one of the first phase and the second phase is ceramic.

33. The method of claim 1, comprising after the growing, modifying the nanoparticulates in the flowing stream while retaining the nanoparticulates within the weight average particle size range.

34. The method of claim 33, wherein the modifying comprises compositional modification of the nanoparticulates.

35. The method of claim 33, wherein the modifying comprises physical modification of the nanoparticulates.

36. The method of claim 33, wherein the modifying comprises homogenizing the nanoparticulates.

37. The method of claim 33, wherein the modifying comprises changing the crystallinity of the nanoparticulates.

38. The method of claim 1, comprising after the forming, collecting the nanoparticulates, the collecting comprising removing the nanoparticulates from the flowing stream.

39. The method of claim 38, wherein the collecting comprises removing the nanoparticulates from the flowing stream into a collecting liquid.

40. The method of claim 39, wherein the collecting liquid comprises a surface-treatment material for surface modifying a surface of the nanoparticulates.

41. The method of claim 1, wherein:
during the introducing, at least a portion of the nongaseous precursor is introduced into the flame; and
the flame discharges into a conduit.

42. The method of claim 41, wherein:
the flame has a maximum cross-sectional area perpendicular to the direction of flow through the flame;
the conduit has adjacent to the flame an internal cross-sectional area perpendicular to the direction of flow in the conduit; and
a ratio of the internal cross-sectional area of the conduit to the maximum cross-sectional area of the flame is at least as large as 1.5.

43. The method of claim 41, wherein the forming comprises introducing a barrier gas into the conduit and flowing the barrier gas adjacent a wall of the conduit to function as a barrier inhibiting deposition of the nanoparticulates on the wall of the conduit.

44. The method of claim 41, wherein during the growing, a wall of the conduit downstream of the flame is heated independent of the flowing stream to inhibit thermophoretic deposition on the wall of the nanoparticulates.

45. The method of claim 41, wherein a wall of the conduit has a mirror finish.

46. The method of claim 41, wherein the flame is disposed within a spiraling flow of barrier gas around the outside of the flame.

47. The method of claim 41, wherein the flame extends through an adjustable aperture.

48. The method of claim 1, wherein the low-melting temperature material comprises at least one member selected from the group consisting of chromium, zinc, antimony, barium, cerium, cobalt, gandolinium, germanium, iron, lanthanum, magnesium, manganese, rhodium, strontium, thorium, titanium and yttrium.

49. The method of claim 1, wherein the composition of the nanoparticulates is transparent.

50. The method of claim 1, wherein the composition of the nanoparticulates is an electrical conductor.

51. The method of claim 1, wherein the composition of the nanoparticulates is a transparent electrical conductor.

52. The method of claim 1, wherein the composition of the nanoparticulates is an electrical insulator.

53. The method of claim 1, wherein the composition of the nanoparticulates is dielectric.

54. The method of claim 1, wherein the composition of the nanoparticulates is an electrical semiconductor.

55. The method of claim 1, wherein the composition of the nanoparticulates is a thermal conductor.

56. The method of claim 1, wherein the composition of the nanoparticulates is a thermal insulator.

57. The method of claim 1, wherein the composition of the nanoparticulates is luminescent.

58. The method of claim 1, wherein the composition of the nanoparticulates is a phosphor.

59. The method of claim 1, wherein the composition of the nanoparticulates is magnetic.

60. The method of claim 1, wherein the composition of the nanoparticulates is a pigment.

61. A method of making metal-containing nanoparticulates, the method comprising:
introducing into a flame reactor heated by at least one flame a nongaseous precursor including a component for inclusion in a material of the nanoparticulates, the material comprising a metal; and
forming the nanoparticulates, the forming comprising transferring substantially the entire component of the nongaseous precursor through a gas phase of a flowing stream in the flame reactor and growing in the flowing stream the nanoparticulates comprising the metal phase to a weight average particle size in a range having a lower limit of 1 nanometer and an upper limit of 500 nanometers.

62. The process of claim 61, wherein the metal-containing nanoparticulates comprise nanoparticulates selected from the group consisting of catalyst particles, phosphor particles, and magnetic particles.

63. The process of claim 61, further comprising the steps of:
collecting the metal-containing nanoparticulates; and
dispersing the metal-containing nanoparticulates in a liquid medium.

64. The process of claim 63, further comprising the step of:
applying the liquid medium onto a surface.

65. The process of claim 64, further comprising the steps of:
heating the surface to a maximum temperature below 500° C. to form at least a portion of an electronic component.

66. The process of claim 64, wherein the applying comprises ink jet printing or screen printing.

67. The process of claim 64, further comprising the step of:
heating the surface to form at least a portion of a feature selected from the group consisting of a conductor, resistor, phosphor, dielectric, and a transparent conducting oxide.

68. The process of claim 67, wherein the feature comprises a ruthenate resistor or a titanate dielectric.

69. The process of claim 67, wherein the feature comprises a phosphor.

70. The process of claim 67, wherein the surface is heated to a maximum temperature below 500° C.

71. The process of claim 61, further comprising the steps of:
collecting the metal-containing nanoparticulates; and
forming an electrode from the metal-containing nanoparticulates.

72. The process of claim 71, wherein the electrode comprises a fuel cell electrode.

73. The process of claim 72, wherein the metal-containing nanoparticulates exhibit corrosion resistance.

74. The process of claim 61, wherein the metal-containing nanoparticulates maintain a surface area of at least 30 m²/g after exposure to air at 900° C. for 4 hours

75. The process of claim 61, further comprising the steps of:
collecting the metal-containing nanoparticulates; and
forming an optical feature from the metal-containing nanoparticulates.

76. A method of making nanoparticulates, the method comprising:
introducing a nongaseous precursor for the nanoparticulates into a flame reactor heated by at least one flame, the nongaseous precursor being a first precursor including a component for inclusion in a material of the nanoparticulates and the nongaseous precursor being introduced into the flame reactor at a first location;
forming the nanoparticulates, the forming comprising:
transferring substantially the entire component of the nongaseous precursor through a gas phase of a flowing stream in the flame reactor;
adding second precursor for the nanoparticulates to the flowing stream at a second location in the flame reactor, the second location being downstream of the first location; and
growing the nanoparticulates in the flowing stream to a weight average particle size in a range having a lower limit of 1 nanometer and an upper limit of 500 nanometers.

77. A method of making multi-phase nanoparticulates, the method comprising:
introducing a first precursor for the nanoparticulates into a flame reactor heated by at least one flame, the first precursor being a nongaseous precursor including a component for inclusion in a material of the nanoparticulates, the material being a first phase of the nanoparticulates;
introducing a second precursor for the nanoparticulates into the flame reactor, the second precursor including a different component for inclusion in a second phase of the nanoparticulates, wherein the second phase is different from the first phase;
forming the nanoparticulates, the forming comprising:
transferring substantially the entire component of the first precursor through a gas phase of a flowing stream in the flame reactor; and
growing the nanoparticulates in the flowing stream to a weight average particle size in a range having a lower limit of 1 nanometer and an upper limit of 500 nanometers and including both the first phase and the second phase;
wherein the second phase comprises a flux aiding the growth of the nanoparticulates during the growing.

78. The method of claim 77, wherein the first phase is a metal.

79. The method of claim 78, wherein the metal comprises at least one member selected from the group consisting of boron, chromium, hafnium, iridium, molybdenum, niobium, osmium, rhenium, ruthenium, tantalum, tungsten and zirconium.

80. The method of claim 77, wherein the first phase is ceramic.

81. The method of claim 80, wherein the ceramic is selected from the group consisting of oxides, nitrides, carbides, tellurides, selinides, titanates, tantalates and glasses.

82. The method of claim 77, wherein the first phase is a phosphor material and the second phase is a salt.

83. The method of claim 82, wherein the salt is selected from the group consisting of sodium chloride and potassium chloride.

84. A method of making multi-phase nanoparticulates, the method comprising:
introducing a first precursor for the nanoparticulates into a flame reactor heated by at least one flame, the first precursor being a nongaseous precursor including a component for inclusion in a material of the nanoparticulates, the material being a first phase of the nanoparticulates;
introducing a second precursor for the nanoparticulates into the flame reactor, the second precursor including a different component for inclusion in a second phase of the nanoparticulates, wherein the second phase is different than the first phase;
forming the nanoparticulates, the forming comprising:
transferring substantially the entire component of the first precursor through a gas phase of a flowing stream in the flame reactor; and
growing the nanoparticulates in the flowing stream to a weight average particle size in a range having a lower limit of 1 nanometer and an upper limit of 500 nanometers and including both the first phase and the second phase;
wherein the second phase has a lower melting temperature than a melting temperature of the first phase; and
wherein the growing comprises maintaining the flowing stream for some period of time below the melting temperature of the first phase and at or above the melting temperature of the second phase.

85. A method of making nanoparticulates, the method comprising:
introducing into a flame reactor heated by at least one flame a nongaseous precursor including a component for inclusion in a material of the nanoparticulates; and
forming the nanoparticulates, the forming comprising transferring substantially the entire component of the nongaseous precursor through a gas phase of a flowing stream in the flame reactor and growing in the flowing stream the nanoparticulates to a weight average particle size in a range having a lower limit of 1 nanometer and an upper limit of 500 nanometers;
wherein during the growing, the flowing stream flows through a conduit, and an interior wall portion of the conduit adjacent the flowing stream is maintained at or above a temperature of the flowing stream when passing the wall portion thereby inhibiting thermophoretic deposition of the nanoparticulates on the wall portion.

86. A method of making nanoparticulates, the method comprising:
introducing into a flame reactor heated by at least one flame a nongaseous precursor including a component for inclusion in a material of the nanoparticulates; and
forming the nanoparticulates, the forming comprising transferring substantially the entire component of the nongaseous precursor through a gas phase of a flowing stream in the flame reactor and growing in the flowing stream the nanoparticulates to a weight average particle size in a range having a lower limit of 1 nanometer and an upper limit of 500 nanometers;
wherein the forming comprises flowing, during at least a portion of the growing, a barrier gas adjacent a wall of the flame reactor concurrently with flow of the flowing stream, thereby inhibiting deposition of the nanoparticulates onto the wall.

87. A method of making nanoparticulates, the method comprising:
introducing into a flame of a flame reactor a nongaseous precursor including a component for inclusion in a material of the nanoparticulates; and
forming the nanoparticulates, the forming comprising transferring substantially the entire component of the nongaseous precursor through a gas phase of a flowing stream in the flame reactor and growing in the flowing stream the nanoparticulates to a weight average particle size in a range having a lower limit of 1 nanometer and an upper limit of 500 nanometers;
wherein the flame discharges into a conduit and the flame projects through an aperture of smaller area than a cross-sectional area of the conduit as determined in a plane perpendicular to the direction of flow of the flowing stream.

88. The method of claim 87, wherein the wherein a ratio of the cross-sectional area of the conduit to the area of the aperture is in a range of from 1.5 to 10.

89. A method of making nanoparticulates, the method comprising:
introducing into a flame reactor a nongaseous precursor, being a first precursor, for the nanoparticulates, and a second precursor for the nanoparticulates, each of the first precursor and the second precursor comprising a component for inclusion in the nanoparticulates, the second precursor being nongaseous;
forming the nanoparticulates, the forming comprising:
transferring substantially the entire component of each of the first precursor and the second precursor through a gas phase in the flame reactor; and
growing the nanoparticulates to a weight average particle size in a range having a lower limit of 1 nanometer and an upper limit of 500 nanometers;
wherein, during the introducing, the first nongaseous precursor and the second precursor are separately introduced into the flame reactor.

90. A method of making nanoparticulates, the method comprising:
introducing into a flame reactor a nongaseous precursor including a component for inclusion in a material of the nanoparticulates; and
after the introducing, forming the nanoparticulates, the forming comprising transferring substantially the entire component through a gas phase in the flame reactor and growing the nanoparticulates to a weight average particle size in a range having a lower limit of 1 nanometer and an upper limit of 500 nanometers;
wherein, the flame reactor comprises a plurality of flames and during the introducing, a different portion of the nongaseous precursor is introduced into each of two or more of the plurality of flames.
